(19) United States
(12) Patent Application Publication
(10) Pub. No.: US 2024/0348752 A1
(43) Pub. Date: Oct. 17, 2024

(54) PROJECTION DEVICE AND COMMUNICATION DEVICE

(71) Applicant: NEC Corporation, Minato-ku, Tokyo (JP)

(72) Inventors: Koya TAKATA, Tokyo (JP); Hisashi MIZUMOTO, Tokyo (JP); Fujio OKUMURA, Kanagawa (JP)

(73) Assignee: NEC Corporation, Minato-ku, Tokyo (JP)

(21) Appl. No.: 18/683,284

(22) PCT Filed: Aug. 27, 2021
(86) PCT No.: PCT/JP2021/031473

§ 371 Date: Feb. 13, 2024

(51) Int. Cl. H04N 9/31; G03B 21/28

(52) U.S. Cl. CPC H04N 9/3102; G03B 21/28; H04N 9/3155; H04N 9/3164

(57) ABSTRACT

A projection device that includes a light source, a spatial light modulator including a modulation portion irradiated with a beam emitted from the light source, the spatial light modulator modulating a phase of the emitted beam in the modulation portion, a control unit that sets a phase image for forming a desired image in the modulation portion of the spatial light modulator, and controls the light source in such a way that the modulation portion, in which the phase image is set, is irradiated with the beam, and a curved mirror having a curved reflective surface irradiated with a modulated beam modulated by the modulation portion of the spatial light modulator, the curved mirror reflecting the modulated beam on the reflective surface, and projecting a projection beam having a projection angle enlarged according to a curvature of the reflective surface.

### TECHNICAL FIELD

The present disclosure relates to a projection device or the like that projects spatial light.

### BACKGROUND ART

In optical space communication, a light signal propagating in a space (hereinafter also referred to as a spatial light signal) is transmitted or received without using a medium such as an optical fiber. An optical system such as a projection lens is used to project a spatial light signal that spreads and propagates in a space. In order to increase a projection angle of the spatial light signal, a projection lens having a short focal length is used.

PTL 1 discloses an image projection device using a refractive-type projection optical system. The device according to PTL 1 includes a projection optical system including a refractive optical system and a refractive/reflective optical element. The refractive optical system and the refractive/reflective optical element are arranged in order from an image display surface side toward a projection surface side. The refractive optical system includes a plurality of lenses. The refractive/reflective optical element includes a reflective surface element having a reflective surface, and a refractive medium part disposed closely to the reflective surface. The reflective surface element and the refractive medium part are configured as a single optical element by bonding them on their boundary surfaces.

### CITATION LIST

### Patent Literature

PTL 1: JP 2020-042103 A

### SUMMARY OF INVENTION

### Technical Problem

In the projection optical system according to PTL 1, a distance of an optical path for passing through the refractive medium part is increased by a plurality of reflective surfaces of the reflective surface element of the refractive/reflective optical element. Therefore, it is possible to achieve a projection lens having a short focal length in which the refractive power of the entire refractive/reflective optical element is maintained while using a material having a small refractive index for the refractive medium part. However, the projection optical system according to PTL 1 has problems in that the refractive optical system needs to include a plurality of lenses, and the configurations of the reflective surface element and the refractive medium part of the refractive/reflective optical element are complicated. In addition, the projection optical system according to PTL 1 has many restrictions in designing a plurality of lenses included in the refractive optical system, the refractive/reflective optical element including the reflective surface element and the refractive medium part, and the like.

An object of the present disclosure is to provide a projection device or the like capable of projecting spatial light forming a desired image with a simple configuration.

### Solution to Problem

A projection device according to an aspect of the present disclosure includes a light source, a spatial light modulator including a modulation portion irradiated with a beam emitted from the light source, the spatial light modulator modulating a phase of the emitted beam in the modulation portion, a control unit that sets a phase image for forming a desired image in the modulation portion of the spatial light modulator, and controls the light source in such a way that the modulation portion, in which the phase image is set, is irradiated with the beam, and a curved mirror having a curved reflective surface irradiated with a modulated beam modulated by the modulation portion of the spatial light modulator, the curved mirror reflecting the modulated beam on the reflective surface, and projecting a projection beam having a projection angle enlarged according to a curvature of the reflective surface.

### Advantageous Effects of Invention

According to the present disclosure, it is possible to provide a projection device or the like capable of projecting spatial light forming a desired image with a simple configuration.

### BRIEF DESCRIPTION OF DRAWINGS

FIG. 1 is a conceptual diagram illustrating an example of a configuration of a projection device according to a first example embodiment.

FIG. 2 is a conceptual diagram for explaining an example of an unnecessary component shielded by a shield of the projection device according to the first example embodiment.

FIG. 3 is a conceptual diagram for explaining an example in which an unnecessary component is shielded by the shield of the projection device according to the first example embodiment.

FIG. 4 is a conceptual diagram for explaining an example in which a projection beam is projected by the projection device according to the first example embodiment.

FIG. 5 is a conceptual diagram for explaining another example in which a projection beam is projected by the projection device according to the first example embodiment.

FIG. 6 is a conceptual diagram for explaining a difference in projection angle depending on a curvature of a reflective surface of a curved mirror in the projection device according to the first example embodiment.

FIG. 7 is a conceptual diagram for explaining a difference in projection angle depending on a distance between a spatial light modulator and a curved mirror in the projection device according to the first example embodiment.

FIG. 8 is a conceptual diagram for explaining an example in which a projection range of the projection device according to the first example embodiment is set to 180 degrees.

FIG. 9 is a conceptual diagram for explaining a composite image set in a modulation portion of a spatial light modulator of the projection device according to the first example embodiment.

FIG. 10 is a conceptual diagram illustrating an example of a condensing point of light emitted from a light source of the projection device according to the first example embodiment.

FIG. 11 is a conceptual diagram illustrating another example of a condensing point of light emitted from the light source of the projection device according to the first example embodiment.

FIG. 12 is a conceptual diagram illustrating an example of a configuration of a projection device according to a first modification of the first example embodiment.

FIG. 13 is a conceptual diagram illustrating an example of a configuration of a projection device according to a second modification of the first example embodiment.

FIG. 14 is a conceptual diagram illustrating an example of a configuration of a projection device according to a third modification of the first example embodiment.

FIG. 15 is a conceptual diagram illustrating an example of a configuration of a projection device according to a second example embodiment.

FIG. 16 is a conceptual diagram for explaining a projection range of a projection beam projected by the projection device according to the second example embodiment.

FIG. 17 is a conceptual diagram illustrating an example of a configuration of a projection device according to a third example embodiment.

FIG. 18 is a conceptual diagram for explaining a projection range of a projection beam projected by the projection device according to the third example embodiment.

FIG. 19 is a conceptual diagram illustrating an example of a configuration of a projection device according to a fourth example embodiment.

FIG. 20 is a conceptual diagram illustrating an example of a positional relationship between a light source and a spatial light modulator in the projection device according to the fourth example embodiment.

FIG. 21 is a conceptual diagram for explaining an example in which a projection beam is projected by the projection device according to the fourth example embodiment.

FIG. 22 is a block diagram illustrating an example of a configuration of a communication device according to a fifth example embodiment.

FIG. 23 is a conceptual diagram illustrating an example of a configuration of a reception device included in the communication device according to the fifth example embodiment.

FIG. 24 is a conceptual diagram for explaining an example in which the fifth example embodiment is applied.

FIG. 25 is a conceptual diagram for explaining an example of a communication network in the example in which the fifth example embodiment is applied.

FIG. 26 is a conceptual diagram for explaining an example of a configuration of a transmission device included in the communication device used in the communication network in the example in which the fifth example embodiment is applied.

FIG. 27 is a conceptual diagram illustrating an example of a configuration of a projection device according to a sixth example embodiment.

FIG. 28 is a block diagram illustrating an example of a hardware configuration for implementing control and processing according to each example embodiment.

### EXAMPLE EMBODIMENT

Hereinafter, embodiments of the present invention will be described with reference to the drawings. However, it should be noted that the example embodiments to be described below are limited to be technically preferable in carrying out the present invention, but the scope of the invention is not limited to the following example embodiments. Note that, in all the drawings used to describe the following example embodiments, the same reference signs are given to the same parts unless there is a particular reason. Furthermore, in the following example embodiments, the description of the same configurations and operations may not be repeated.

In all the drawings used to describe the following example embodiments, a direction of an arrow is an example, and does not limit a direction of light or a signal. In addition, in the drawings, a line indicating a trajectory of light is conceptual, and does not accurately indicate an actual traveling direction or state of light. For example, in the drawings, a change in traveling direction or state of light caused by refraction, reflection, diffraction, diffusion, or the like at an interface between air and a substance may be omitted, or a light flux may be expressed by a single line.

### First Example Embodiment

First, a projection device according to a first example embodiment will be described with reference to the drawings. The projection device according to the present example embodiment is used for optical space communication in which a light signal propagating in a space (hereinafter also referred to as a spatial light signal) is transmitted or received without using a medium such as an optical fiber. The projection device according to the present example embodiment is suitable for transmitting a spatial light signal to communication targets located at substantially the same height. The projection device according to the present example embodiment may be used for applications other than optical space communication as long as the projection device is used to project light propagating in a space.

### (Configuration)

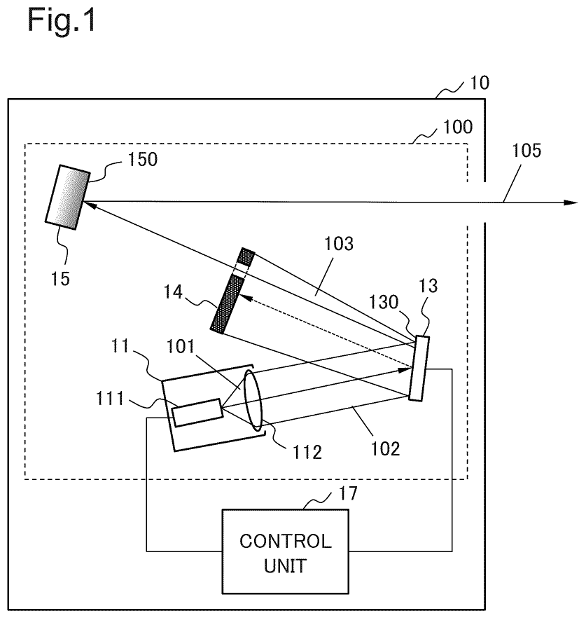

FIG. 1 is a conceptual diagram illustrating an example of a configuration of a projection device 10 according to the present example embodiment. The projection device 10 includes a light source 11, a spatial light modulator 13, a shield 14, a curved mirror 15, and a control unit 17. The light source 11, the spatial light modulator 13, the shield 14, and the curved mirror 15 constitute a projection unit 100. FIG. 1 is a side view of an internal configuration of the projection device 10 as viewed from the side. FIG. 1 is conceptual, and does not accurately indicate a positional relationship between the components, a traveling direction of light, etc.

The light source 11 includes an emitter 111 and a lens 112. The emitter 111 emits a laser beam 101 in a predetermined wavelength band according to the control of the control unit 17. The wavelength of the laser beam 101 emitted from the light source 11 is not particularly limited, and may be selected according to the application. For example, the emitter 111 emits a laser beam 101 in the visible or infrared wavelength band. For example, near-infrared light in the range of 800 to 900 nanometers (nm) can raise the laser class, thereby improving sensitivity by about a one-digit number as compared with the other wavelength bands. For example, a high-output laser light source can be used for infrared light in a wavelength band of 1.55 micrometers (μm). As an infrared laser light source in a wavelength band of 1.55 μm, an aluminum gallium arsenide phosphorus (AlGaAsP)-based laser light source, an indium gallium arsenide (InGaAs)-based laser light source, or the like can be used. The longer the wavelength of the laser beam 101 is, the larger the diffraction angle can be set and the higher the energy can be set.

The lens 112 enlarges the laser beam 101 emitted from the emitter 111 in accordance with a size of a modulation portion 130 of the spatial light modulator 13. The laser beam 101 emitted from the emitter 111 is enlarged by the lens 112 and emitted from the light source 11. A beam 102 emitted from the light source 11 travels toward the modulation portion 130 of the spatial light modulator 13.

The spatial light modulator 13 includes a modulation portion 130 irradiated with the beam 102. The modulation portion 130 of the spatial light modulator 13 is irradiated with the beam 102 emitted from the light source 11. In the modulation portion 130 of the spatial light modulator 13, a pattern according to an image to be displayed by a projection beam 105 is set according to the control of the control unit 17. The beam 102 incident on the modulation portion 130 of the spatial light modulator 13 is modulated according to the pattern set in the modulation portion 130 of the spatial light modulator 13. The modulated beam 103 modulated by the modulation portion 130 of the spatial light modulator 13 travels toward a reflective surface 150 of the curved mirror 15.

For example, the spatial light modulator 13 is achieved by a spatial light modulator using ferroelectric liquid crystal, homogeneous liquid crystal, vertical alignment liquid crystal, or the like. For example, the spatial light modulator 13 can be achieved by liquid crystal on silicon (LCOS). Alternatively, the spatial light modulator 13 may be achieved by a micro electro mechanical system (MEMS). The phase modulation-type spatial light modulator 13 can be operated to sequentially switch a location where a projection beam 105 is projected, thereby concentrating energy on an image portion. Therefore, in a case where the phase modulation-type spatial light modulator 13 is used, an image can be displayed brighter than those in the other methods if the output of the light source 11 is the same as those in the other methods.

The modulation portion 130 of the spatial light modulator 13 is divided into a plurality of regions (also referred to as tiling). For example, the modulation portion 130 is divided into rectangular regions (also referred to as tiles) having a desired aspect ratio. A phase image is allocated to each of the plurality of tiles set in the modulation portion 130. Each of the plurality of tiles includes a plurality of pixels. A phase image corresponding to an image to be projected is set to each of the plurality of tiles. The phase images set to the plurality of tiles, respectively, may be the same or different.

A phase image is tiled to each of the plurality of tiles allocated to the modulation portion 130. For example, a phase image generated in advance is set to each of the plurality of tiles. When the modulation portion 130 is irradiated with the beam 102 in a state where the phase images are set to the plurality of tiles, a modulated beam 103 that forms an image corresponding to a phase image of each tile is emitted. A larger number of tiles set in the modulation portion 130 make it possible to display a clearer image, but a smaller number of pixels of each tile results in a lower resolution. Therefore, the size and number of tiles set in the modulation portion 130 are set according to the application.

The shield 14 (also referred to as a first shield) is disposed between the spatial light modulator 13 and the curved mirror 15. In other words, the shield 14 is disposed on an optical path of the modulated beam 103 modulated by the modulation portion 130 of the spatial light modulator 13. The shield 14 is an aperture in which a slit-shaped opening is formed in a portion through which light forming a desired image passes. In other words, the shield 14 is a frame that shields an unnecessary light component included in the modulated beam 103 and defines an outer edge of a display area of the projection beam 105. The shield 14 allows light forming a desired image to pass therethrough and shields an unnecessary light component. For example, the shield 14 shields 0th-order light or a ghost image included in the modulated beam 103. For example, the opening of the shield 14 is formed in a rectangular shape, an elliptical shape, or a circular shape. As the shield 14, a 0th-order light shielding element (not illustrated) that shields 0th-order light may be used. The 0th-order light shielding element is an element in which a portion that absorbs/reflects light is formed. The 0th-order light shielding element is disposed on an optical path of 0th-order light. For example, a transparent element such as glass having a portion painted black so as not to transmit light can be used as the 0th-order light shielding element. Furthermore, a portion that shields 0th-order light included in the modulated beam 103 may be provided inside the opening of the shield 14.

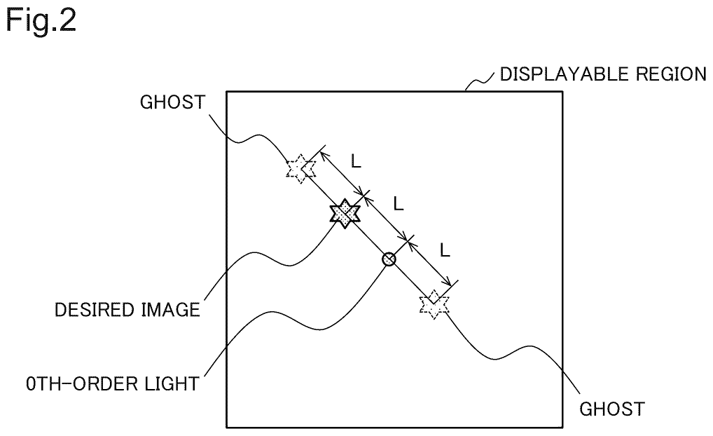

FIG. 2 is a conceptual diagram illustrating an example of an image displayed on a projection surface in a case where the shield 14 is not used. In the example of FIG. 2, in addition to a desired image, 0th-order light and ghost images derived from higher-order diffracted light are displayed in a displayable region of the projection surface. The desired image, the 0th-order light, and the ghost image are displayed at equal intervals L (L is a positive real number).

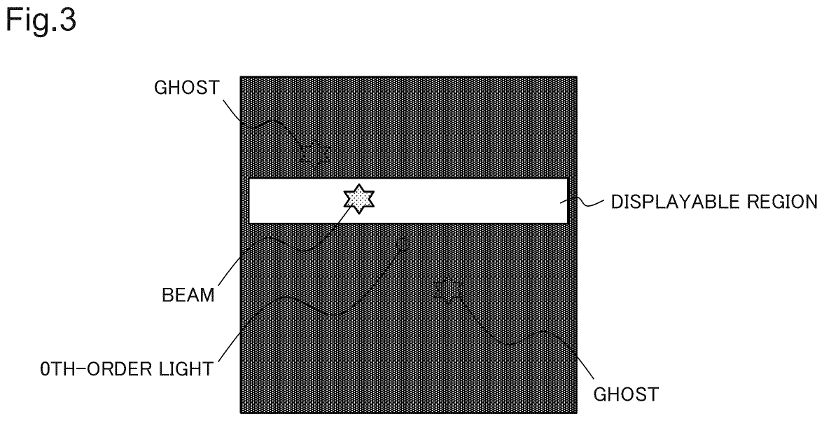

FIG. 3 is a conceptual diagram illustrating an example of an image displayed on a projection surface in a case where the shield 14 in which a slit-shaped opening is formed in accordance with a projection range of a desired image is used. In the displayable region of the projection surface, a component of a projection beam 105 that has passed through the slit-shaped opening of the shield 14 is displayed. The 0th-order light and the ghost image are shielded by the shield 14. In the example of FIG. 3, in the displayable region of the projection surface, the desired image is displayed, while the 0th-order light and the ghost image are not displayed. Note that the slit-type opening in FIG. 3 has a shape suitable for transmitting a spatial light signal toward communication targets located at substantially the same height, and does not limit the shape of the slit-type opening formed in the shield 14.

The curved mirror 15 is a reflecting mirror having a curved reflective surface 150. The reflective surface 150 of the curved mirror 15 has a curvature in accordance with a projection angle of a projection beam 105. In the example of FIG. 1, the reflective surface 150 of the curved mirror 15 has a shape like a side surface of a cylinder. For example, the reflective surface 150 of the curved mirror 15 may be a spherical surface. For example, the reflective surface 150 of the curved mirror 15 may be a free-form surface. For example, the reflective surface 150 of the curved mirror 15 may have a shape in which a plurality of curved surfaces are combined rather than a single curved surface. For example, the reflective surface 150 of the curved mirror 15 may have a shape in which a curved surface and a flat surface are combined.

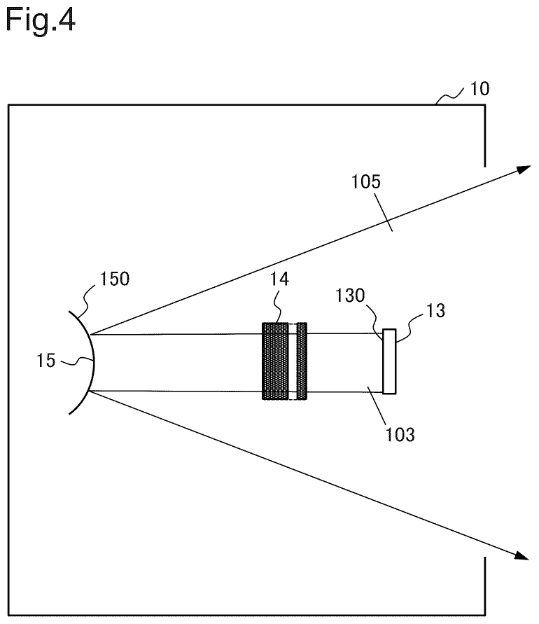

FIG. 4 is a conceptual diagram for explaining an example in which a projection beam 105 reflected by the reflective surface 150 of the curved mirror 15 is projected. FIG. 4 is a plan view of the internal configuration of the projection device 10 as viewed from above. In FIG. 4, the light source 11 is omitted. FIG. 4 is conceptual, and does not accurately indicate a positional relationship between the components, a traveling direction of light, etc.

The curved mirror 15 is disposed on an optical path of a modulated beam 103 with the reflective surface 150 facing the modulation portion 130 of the spatial light modulator 13. The reflective surface 150 of the curved mirror 15 is irradiated with the modulated beam 103 that has been modulated by the modulation portion 130 of the spatial light modulator 13 and has passed through the slit-shaped opening of the shield 14. The beam (the projection beam 105) reflected by the reflective surface 150 of the curved mirror 15 is projected after being enlarged at an enlargement ratio according to a curvature of the reflective surface 150. In the example of FIG. 4, the projection beam 105 is enlarged along the horizontal direction (the vertical direction of the paper surface of FIG. 4) according to the curvature of the irradiation range of the modulated beam 103 on the reflective surface 150 of the curved mirror 15.

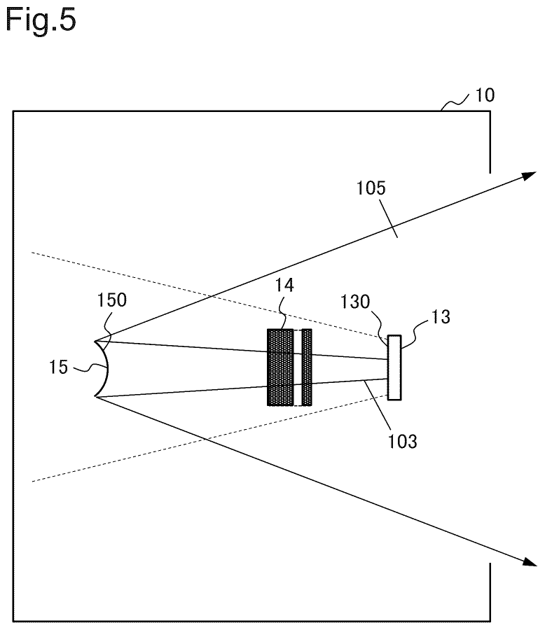

FIG. 5 is a conceptual diagram for explaining another example in which a projection beam 105 reflected by the reflective surface 150 of the curved mirror 15 is projected. In the example of FIG. 5, only a modulated beam 103 modulated near the center of the modulation portion 130 of the spatial light modulator 13 is reflected by the reflective surface 150 of the curved mirror 15. FIG. 5 is a plan view of the internal configuration of the projection device 10 as viewed from above. In FIG. 5, the light source 11 is omitted. FIG. 5 is conceptual, and does not accurately indicate a positional relationship between the components, a traveling direction of light, etc.

The curved mirror 15 is disposed on an optical path of a modulated beam 103 with the reflective surface 150 facing the modulation portion 130 of the spatial light modulator 13. The reflective surface 150 of the curved mirror 15 is irradiated with the modulated beam 103 that has been modulated near the center of the modulation portion 130 of the spatial light modulator 13 and has passed through the slit-shaped opening of the shield 14. The modulated beam 103 modulated in a peripheral portion of the modulation portion 130 of the spatial light modulator 13 travels to a region deviated from the reflective surface 150 of the curved mirror 15. The beam (the projection beam 105) reflected by the reflective surface 150 of the curved mirror 15 is projected after being enlarged at an enlargement ratio according to a curvature of the reflective surface 150. In the example of FIG. 5, the projection beam 105 is enlarged along the horizontal direction (the vertical direction of the paper surface of FIG. 5) according to the curvature of the irradiation range of the modulated beam 103 on the reflective surface 150 of the curved mirror 15. The modulated beam 103 modulated by the modulation portion 130 of the spatial light modulator 13 tends to have a larger intensity toward the center of the modulation portion 130 and have a smaller intensity toward the periphery of the modulation portion 130. In the configuration of FIG. 5, the low-intensity modulated beam 103 modulated in the peripheral portion of the modulation portion 130 is not used, but the high-intensity modulated beam 103 modulated near the center of the modulation portion 130 is used as a projection beam 105.

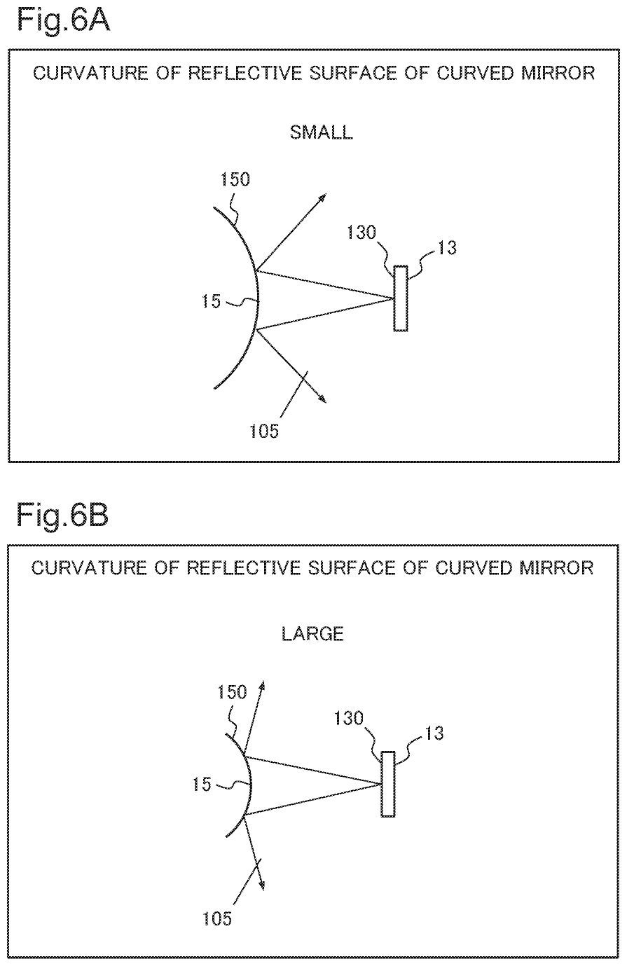

FIG. 6 is a conceptual diagram illustrating an example of a relationship between a curvature of the reflective surface 150 of the curved mirror 15 and a projection angle of the projection beam 105. In the example of FIG. 6, a distance between the spatial light modulator 13 and the curved mirror 15 in a case (1) where the reflective surface 150 of the curved mirror 15 has a small curvature is the same as that in a case (2) where the reflective surface 150 of the curved mirror 15 has a large curvature. A projection angle is larger in the case (2) where the reflective surface 150 of the curved mirror 15 has a large curvature than in the case (1) where the reflective surface 150 of the curved mirror 15 has a small curvature. In other words, a projection angle is larger in a case (2) where the reflective surface 150 of the curved mirror 15 has a small curvature radius than in a case (1) where the reflective surface 150 of the curved mirror 15 has a large curvature radius. That is, in order to increase the projection angle, the curvature of the reflective surface 150 of the curved mirror 15 may be decreased. On the other hand, in order to reduce the projection angle, the curvature of the reflective surface 150 of the curved mirror 15 may be increased.

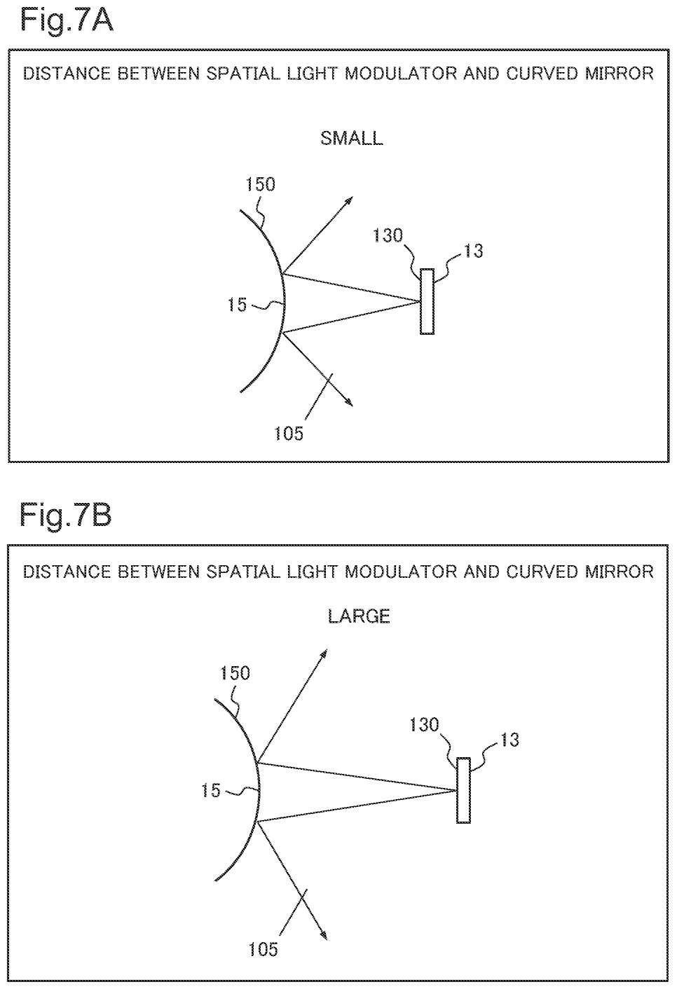

FIG. 7 is a conceptual diagram illustrating an example of a relationship between a distance between the spatial light modulator 13 and the curved mirror 15 and a projection angle of the projection beam 105. In the example of FIG. 7, a curvature of the curved mirror 15 in a case (3) where a distance between the spatial light modulator 13 and the curved mirror 15 is small is the same as that in a case (4) where a distance between the spatial light modulator 13 and the curved mirror 15 is large. An incident angle/reflection angle of the modulated beam 103 with respect to the reflective surface 150 is larger and a projection angle is large in the case (4) where the distance between the spatial light modulator 13 and the curved mirror 15 is larger than in the case (3) where the distance between the spatial light modulator 13 and the curved mirror 15 is small. That is, in order to increase the projection angle, the distance between the spatial light modulator 13 and the curved mirror 15 may be increased. On the other hand, in order to reduce the projection angle, the distance between the spatial light modulator 13 and the curved mirror 15 may be reduced.

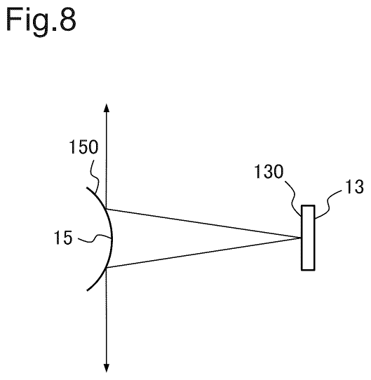

FIG. 8 illustrates an example in which a curvature of the reflective surface 150 of the curved mirror 15 and a distance between the spatial light modulator 13 and the curved mirror 15 are adjusted to set the projection angle to 180 degrees. By adjusting a curvature of the reflective surface 150 of the curved mirror 15 and a distance between the spatial light modulator 13 and the curved mirror 15, the projection angle of the projection device 10 can be set to 180 degrees.

The control unit 17 controls the light source 11 and the spatial light modulator 13. For example, the control unit 17 is achieved by a microcomputer including a processor and a memory. The control unit 17 sets a phase image corresponding to an image to be projected in the modulation portion 130 in accordance with an aspect ratio of tiling set in the modulation portion 130 of the spatial light modulator 13. For example, the control unit 17 sets, in the modulation portion 130, a phase image corresponding to an image according to the application such as image display, communication, or distance measurement. The phase image of the image to be projected may be stored in advance in a storage unit (not illustrated). The shape and size of the image to be projected are not particularly limited.

The control unit 17 drives the spatial light modulator 13 in such a way as to change a parameter for determining a difference between a phase of the beam 102 emitted to the modulation portion 130 of the spatial light modulator 13 and a phase of the modulated beam 103 reflected by the modulation portion 130. The parameter for determining a difference between a phase of the beam 102 emitted to the modulation portion 130 of the spatial light modulator 13 and a phase of the modulated beam 103 reflected by the modulation portion 130 is, for example, a parameter regarding an optical characteristic such as a refractive index or an optical path length. For example, the control unit 17 adjusts the refractive index of the modulation portion 130 by changing the voltage applied to the modulation portion 130 of the spatial light modulator 13. The phase distribution of the beam 102 emitted to the modulation portion 130 of the phase modulation-type spatial light modulator 13 is modulated according to the optical characteristics of the modulation portion 130. The method of driving the spatial light modulator 13 by the control unit 17 is determined according to the modulation scheme of the spatial light modulator 13.

The control unit 17 drives the emitter 111 of the light source 11 in a state where a phase image corresponding to an image to be displayed is set in the modulation portion 130. As a result, the modulation portion 130 of the spatial light modulator 13 is irradiated with the beam 102 emitted from the light source 11 in accordance with a timing at which the phase image is set in the modulation portion 130 of the spatial light modulator 13. The beam 102 emitted to the modulation portion 130 of the spatial light modulator 13 is modulated by the modulation portion 130 of the spatial light modulator 13. The modulated beam 103 modulated by the modulation portion 130 of the spatial light modulator 13 is emitted toward the reflective surface 150 of the curved mirror 15.

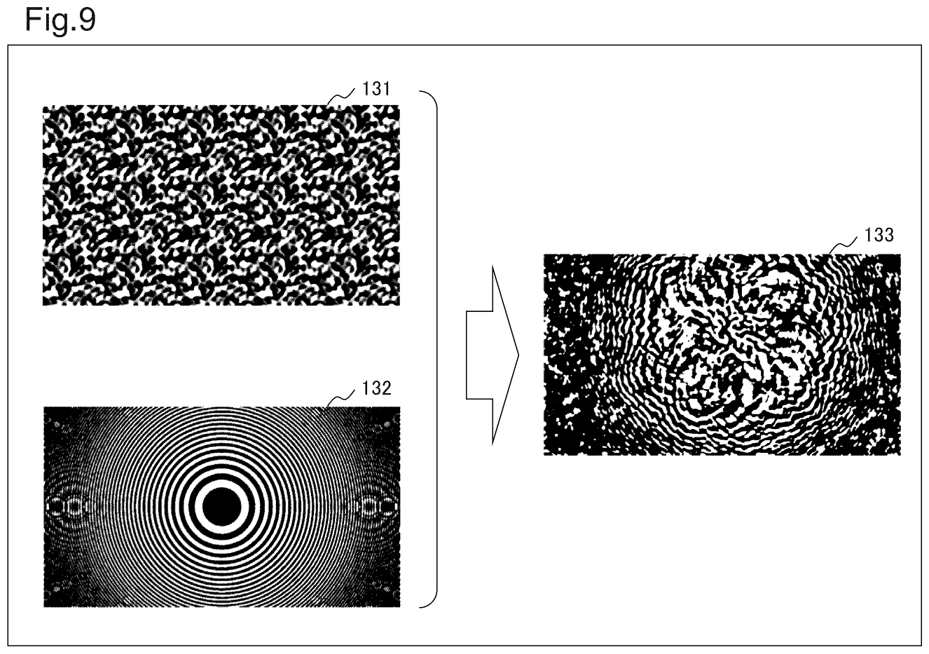

FIG. 9 is a conceptual diagram illustrating an example of a pattern set in the modulation portion 130 of the spatial light modulator 13 by the control unit 17. A composite image 133 is set in the modulation portion 130 of the spatial light modulator 13. The composite image 133 is a pattern obtained by combining a phase image 131 for forming a desired image and a virtual lens image 132 for condensing light forming the desired image. The wavefront of light can be controlled by phase control, similar to diffraction. When the phase changes to a spherical shape, a spherical difference is generated in the wavefront, and a lens effect is generated. The virtual lens image 132 changes the phase of the beam 102 emitted to the modulation portion 130 of the spatial light modulator 13 into a spherical shape, and generates a lens effect by which light is condensed at a position (also referred to as a second condensing point) of a predetermined focal length. The image focused by the virtual lens image 132 is formed on the reflective surface 150 of the curved mirror 15. For example, the composite image 133 may be generated in advance and stored in a storage unit (not illustrated). Note that FIG. 9 is an example and does not limit the patterns of the phase image 131, the virtual lens image 132, and the composite image 133.

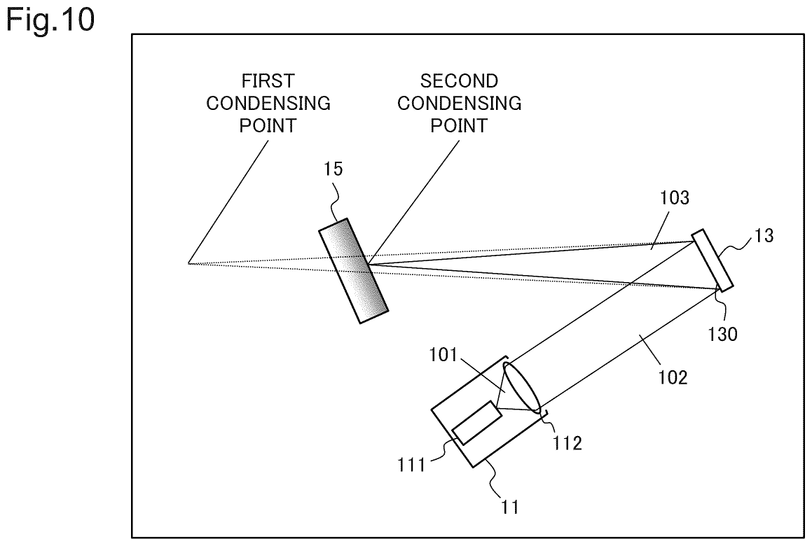

FIG. 10 is a conceptual diagram for explaining an example of a positional relationship between a condensing point (first condensing point) where the 0th-order light is condensed and a second condensing point where the modulated beam 103 is condensed by the virtual lens image 132. In the example of FIG. 10, the first condensing point is set at a position on the back side of the curved mirror 15. Although not illustrated in FIG. 10, the 0th-order light is shielded by the shield 14. When the shield 14 is not provided, the 0th-order light is reflected by the reflective surface 150 of the curved mirror 15, once converged, and then diverged. For example, the 0th-order light may be diverged without being condensed. In this case, the 0th-order light reflected by reflective surface 150 diverges as it goes away from reflective surface 150, and the influence thereof on the image formed by the projection beam 105 is reduced. The second condensing point is set on the reflective surface 150 of the curved mirror 15. An image formed by the virtual lens image 132 is displayed on the reflective surface 150 of the curved mirror 15. Note that the first condensing point may be set on the reflective surface 150 of the curved mirror 15. If the first condensing point is set on the reflective surface 150 of the curved mirror 15, the virtual lens image 132 is unnecessary, and thus, the phase image 131 may be displayed on the modulation portion 130 of the spatial light modulator 13. When the virtual lens image 132 is not used, the ghost image included in the modulated beam 103 is not defocused, but is shielded by the shield 14. Although not illustrated in FIG. 10, the modulated beam 103 reflected by the reflective surface 150 of the curved mirror 15 is projected as a projection beam 105. The shape of the image displayed on the reflective surface 150 of the curved mirror 15 and the shape of the image displayed on the projection surface by the projection beam 105 show mirror symmetry.

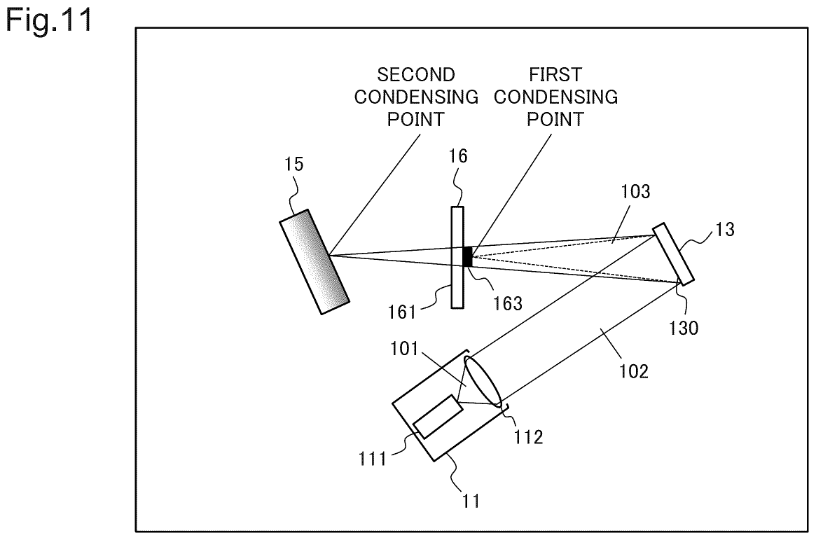

FIG. 11 is a conceptual diagram for explaining another example of a positional relationship between a first condensing point where the 0th-order light is condensed and a second condensing point where the modulated beam 103 is condensed by the virtual lens image 132. In the example of FIG. 11, the first condensing point is set at a position between the spatial light modulator 13 and the curved mirror 15. In the configuration of FIG. 11, a distance between the spatial light modulator 13 and the first condensing point is set to be shorter than that in the configuration of FIG. 10. Therefore, the lens 112 used in the configuration of FIG. 11 is larger than that in the configuration of FIG. 10. A 0th-order light remover 16 that shields 0th-order light is disposed at the position of the first condensing point between the spatial light modulator 13 and the curved mirror 15. The 0th-order light remover 16 removes 0th-order light included in the modulated beam. The second condensing point is set on the reflective surface 150 of the curved mirror 15. An image formed by the virtual lens image 132 is displayed on the reflective surface 150 of the curved mirror 15. The modulated beam 103 reflected by the reflective surface 150 of the curved mirror 15 is projected as a projection beam 105. The shape of the image displayed on the reflective surface 150 of the curved mirror 15 and the shape of the image displayed on the projection surface by the projection beam 105 show mirror symmetry.

The 0th-order light remover 16 includes a support element 161 and a light absorbing element 163. The support element 161 is an element that supports the light absorbing element 163. The light absorbing element 163 is fixed on an optical path of 0th-order light included in the modulated beam 103 by the support element 161. For example, the support element 161 is made of a material such as glass or plastic that easily transmits the modulated beam 103. In a case where the support element 161 is made of plastic, it is preferable to use a material having an entirely uniform surface with small phase unevenness so that retardation is less likely to occur. For example, a plastic material in which birefringence is suppressed is suitable for the support element 161. For example, the support element 161 may include a wire material for fixing the light absorbing element 163. For example, the peripheral edge of the support element 161 can be formed in a frame shape, a wire material is stretched inside the opening of the frame, and the light absorbing element 163 can be fixed by the stretched wire material. In a case where the support element 161 is made of a wire material, it is preferable to use a material that hardly deteriorates due to light so that the deterioration caused by the irradiation of the modulated beam 103 hardly occurs, the material being a wire material that is so thin as not to hinder the passage of the modulated beam 103. The light absorbing element 163 is held on the optical path of 0th-order light by the support element 161. For example, a black body such as carbon is used for the light absorbing element 163. When the wavelength of the laser beam 101 to be used is fixed, it is preferable to use the light absorbing element 163 made of a material that selectively absorbs light having the wavelength of the laser beam 101.

### [First Modification]

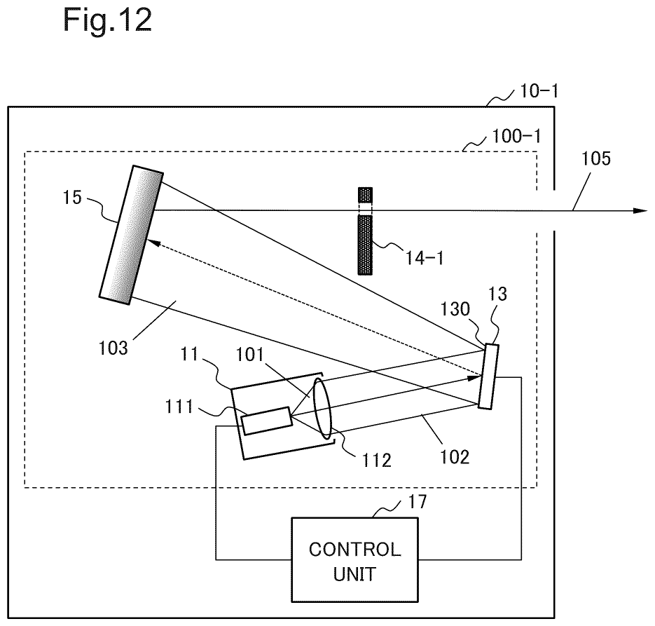

Next, a projection device according to a first modification of the present example embodiment will be described with reference to the drawings. FIG. 12 is a conceptual diagram illustrating an example of a configuration of a projection device 10-1 according to the present modification. The projection device 10-1 according to the present modification differs from the projection device 10 (FIG. 1) in the position of the shield. In the present modification, a shield 14-1 (also referred to as a second shield) is disposed at a stage after the curved mirror 15. The light source 11, the spatial light modulator 13, the shield 14-1, and the curved mirror 15 constitute a projection unit 100-1. The projection device 10-1 has the same configuration as the projection device 10 (FIG. 1), except for the position where the shield 14-1 is disposed.

In the present modification, since the shield 14-1 is disposed at a stage after the curved mirror 15, there are few spatial restrictions due to positional relationships between the light source 11, the spatial light modulator 13, and the curved mirror 15. Therefore, the degree of freedom of the position where the shield 14-1 is disposed is high, and the entire device can be configured compactly. For example, the shield 14-1 may be disposed in a housing of the projection device 10-1. For example, a slit-shaped opening may be formed in the housing of the projection device 10-1 to function as the shield 14-1.

### [Second Modification]

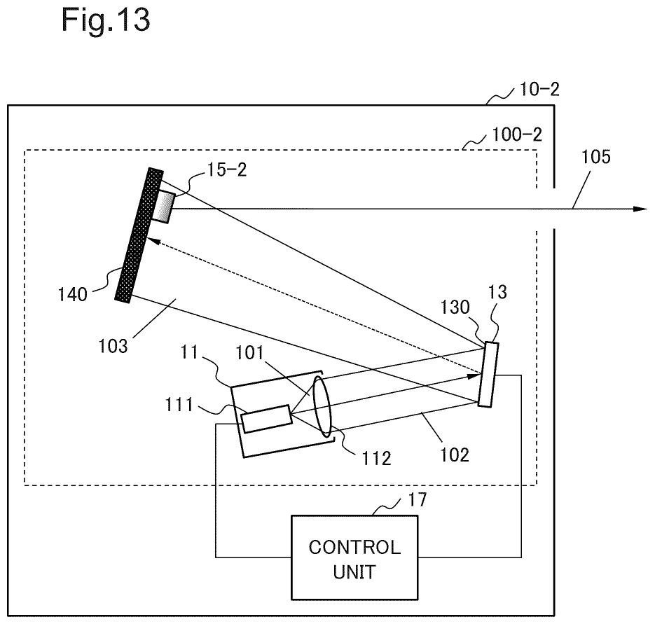

Next, a projection device according to a second modification of the present example embodiment will be described with reference to the drawings. FIG. 13 is a conceptual diagram illustrating an example of a configuration of a projection device 10-2 according to the present modification. The projection device 10-2 according to the present modification differs from the projection device 10 (FIG. 1) in a mechanism for shielding 0th-order light and a ghost image. In the present modification, a shield 140 (also referred to as a third shield) is disposed behind the curved mirror 15-2. The light source 11, the spatial light modulator 13, the shield 140, and the curved mirror 15-2 constitute a projection unit 100-2. The projection device 10-2 has the same configuration as the projection device 10 (FIG. 1), except for the shield 140 and the curved mirror 15-2.

The curved mirror 15-2 is similar to the curved mirror 15 of the projection device 10 (FIG. 1), except that the curved mirror 15-2 is smaller than the curved mirror 15. The curved mirror 15-2 is configured according to a projection direction and a projection angle of the projection beam 105. The curved mirror 15-2 is disposed at a position deviated from a position where 0th-order light or a ghost image included in the modulated beam 103 is emitted. The modulated beam 103 reflected by the curved mirror 15-2 is projected as a projection beam 105.

The shield 140 is disposed behind the curved mirror 15-2. The shield 140 is irradiated with the modulated beam 103 that is not reflected by the curved mirror 15-2. The modulated beam 103 emitted to the shield 140 includes 0th-order light and a ghost image. The shield 140 absorbs the emitted modulated beam 103. For example, a black body such as carbon is used for the shield 140. In addition, in a case where the wavelength of the laser beam 101 to be used is fixed, it is preferable to use the shield 140 including a material that selectively absorbs light having the wavelength of the laser beam 101. The shield 140 does not need to entirely absorb light, and may absorb light at least at a position where the modulated beam 103 is incident. For example, the shield 140 may be formed on an inner surface of a housing of the projection device 10-2.

In the configuration according to the present modification, a component for shielding light is not disposed on the optical path of the modulated beam 103 or the projection beam 105. Therefore, light utilization efficiency can be improved. In addition, according to the present modification, since there are few restrictions on spatial positional relationships between the light source 11, the spatial light modulator 13, and the curved mirror 15 resulting from the arrangement of the shield 140, the entire device can be configured compactly.

### [Third Modification]

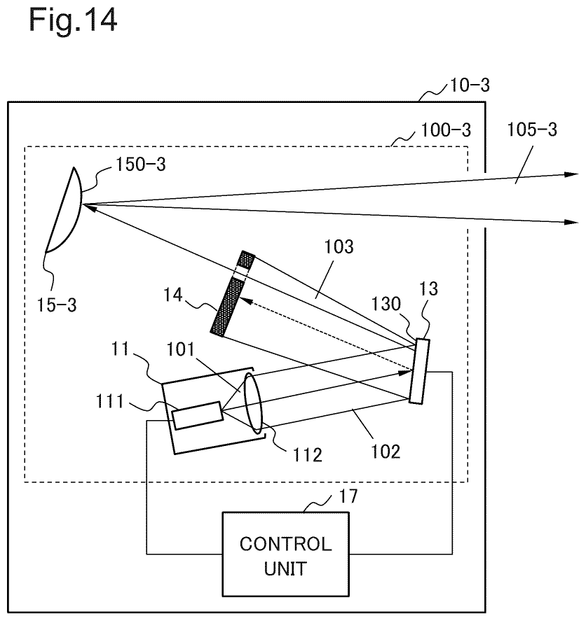

Next, a projection device according to a third modification of the present example embodiment will be described with reference to the drawings. FIG. 14 is a conceptual diagram illustrating an example of a configuration of a projection device 10-3 according to the present modification. In the projection device 10-3 according to the present modification, an axial direction of the curvature center of a reflective surface 150-3 of a curved mirror 15-3 is perpendicular to the axial direction of the curvature center of the reflective surface 150 of the curved mirror 15 of the projection device 10 (FIG. 1). The light source 11, the spatial light modulator 13, the shield 14, and the curved mirror 15-3 constitute a projection unit 100-3. The projection device 10-3 has the same configuration as the projection device 10 (FIG. 1), except for the curved mirror 15-3.

The axial direction of the curvature center of the reflective surface 150-3 of the curved mirror 15-3 is perpendicular to the paper surface of FIG. 14. In the curved mirror 15-3, the axial direction of the curvature center of the reflective surface 150-3 is set perpendicular to the axial direction of the curvature center of the reflective surface 150 of the curved mirror 15 of the projection device 10 (FIG. 1).

The reflective surface 150-3 of the curved mirror 15-3 is irradiated with the modulated beam 103 that has been modulated by the modulation portion 130 of the spatial light modulator 13 and has passed through the slit-shaped opening of the shield 14. The beam (the projection beam 105-3) reflected by the reflective surface 150-3 of the curved mirror 15-3 is projected after being enlarged at an enlargement ratio according to a curvature of the reflective surface 150-3. In the example of FIG. 14, the projection beam 105-3 is enlarged along the vertical direction (the vertical direction of the paper surface of FIG. 14) according to the curvature of the irradiation range of the modulated beam 103 on the reflective surface 150-3 of the curved mirror 15-3. For example, if the reflective surface of the curved mirror has a spherical shape, a projection beam spreading in the horizontal and vertical directions can be projected. The shape of the reflective surface of the curved mirror may be formed according to the application.

As described above, a projection device according to the present example embodiment includes a light source, a spatial light modulator, a shield, and a curved mirror. The light source emits a beam. The spatial light modulator includes a modulation portion irradiated with the beam emitted from the light source. The spatial light modulator modulates a phase of the emitted beam in the modulation portion. The control unit sets a phase image for forming a desired image in the modulation portion of the spatial light modulator. The control unit controls the light source in such a way that the modulation portion, in which the phase image is set, is irradiated with the beam. The shield (also referred to as a first shield) is disposed between the spatial light modulator and the curved mirror. The first shield has a slit opened to allow the modulated beam forming the desired image to pass therethrough, and shields an unnecessary light component included in the modulated beam. The curved mirror has a curved reflective surface irradiated with the modulated beam modulated by the modulation portion of the spatial light modulator. The curved mirror reflects the modulated beam on the reflective surface, and projects a projection beam having a projection angle enlarged according to a curvature of the reflective surface.

The projection device according to the present example embodiment can project a desired image while having a structure in which a projection optical system such as a projection lens is omitted. Furthermore, the projection device according to the present example embodiment removes an unnecessary light component included in a modulated beam. Therefore, the projection device according to the present example embodiment is capable of projecting spatial light forming a desired image from which an unnecessary light component has been removed with a simple configuration.

In an aspect of the present example embodiment, the control unit sets, in the modulation portion of the spatial light modulator, a composite image obtained by combining a virtual lens image for condensing the modulated beam forming the desired image on the reflective surface of the curved mirror with the phase image for forming the desired image. According to the present aspect, a mirror image of the desired image is formed on the reflective surface of the curved mirror. Since the light reflected by the reflective surface of the curved mirror is projected in a focus-free manner, a desired image with less distortion is displayed on the projection surface according to the present aspect.

In an aspect of the present example embodiment, the projection device includes a second shield instead of the first shield. The second shield is disposed on an optical path of the projection beam reflected by the reflective surface of the curved mirror. The second shield has a slit opened to allow the projection beam forming the desired image to pass therethrough, and shields an unnecessary light component included in the projection beam. In the present aspect, since the second shield is disposed at a stage after the curved mirror, there are few spatial restrictions due to the positions of the light source, the spatial light modulator, and the curved mirror. Therefore, according to the present aspect, the degree of freedom of the position where the second shield is disposed is high, and the entire device can be configured compactly.

In an aspect of the present example embodiment, the projection device includes a third shield instead of the first shield. The third shield is disposed behind the curved mirror. The third shield shields an unnecessary light component included in the modulated beam forming the desired image. In the present aspect, a component for shielding light is not disposed on the optical path of the modulated beam or the projection beam. Therefore, according to the present aspect, light utilization efficiency can be improved. In addition, according to the present modification, since there are few restrictions on spatial positional relationships between the light source, the spatial light modulator, and the curved mirror resulting from the arrangement of the first shield, the entire device can be configured compactly.

In an aspect of the present example embodiment, the reflective surface of the curved mirror has a curvature in a plane parallel to a horizontal plane. According to the present aspect, a projection beam projected after being enlarged in the horizontal direction can be projected.

In an aspect of the present example embodiment, the reflective surface of the curved mirror has a curvature in a plane perpendicular to the horizontal plane. According to the present aspect, a projection beam projected after being enlarged in a direction perpendicular to the horizontal direction can be projected.

### Second Example Embodiment

Next, a projection device according to a second example embodiment will be described with reference to the drawings. The projection device according to the present example embodiment includes a reflecting mirror (also referred to as a folding mirror) that reflects a modulated beam modulated by the modulation portion of the spatial light modulator in such a way as to fold the modulated beam toward the curved mirror.

### (Configuration)

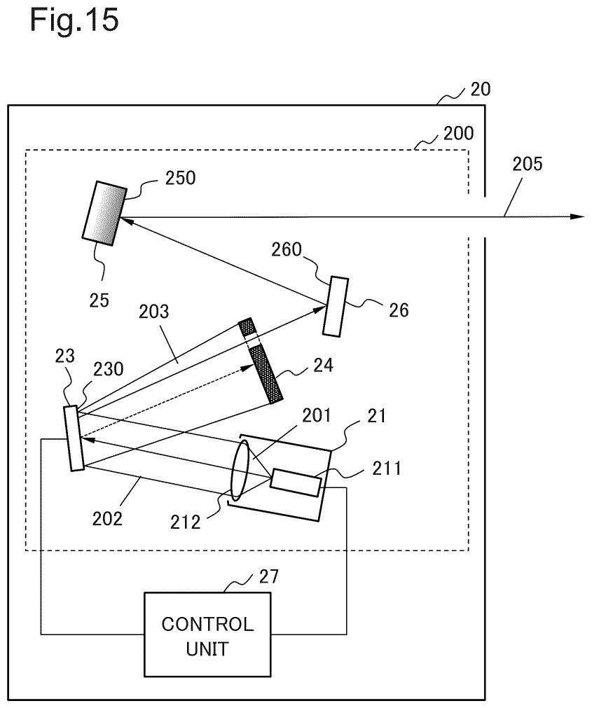

FIG. 15 is a conceptual diagram illustrating an example of a configuration of a projection device 20 according to the present example embodiment. The projection device 20 includes a light source 21, a spatial light modulator 23, a shield 24, a curved mirror 25, a folding mirror 26, and a control unit 27. The light source 21, the spatial light modulator 23, the shield 24, the curved mirror 25, and the folding mirror 26 constitute a projection unit 200. FIG. 15 is a side view of an internal configuration of the projection device 20 as viewed from the side. FIG. 15 is conceptual, and does not accurately indicate a positional relationship between the components, a traveling direction of light, etc.

The light source 21 has the same configuration as the light source 11 of the first example embodiment. The light source 21 includes an emitter 211 and a lens 212. The emitter 211 emits a laser beam 201 in a predetermined wavelength band according to the control of the control unit 27. The lens 212 enlarges the laser beam 201 emitted from the emitter 211 in accordance with a size of a modulation portion 230 of the spatial light modulator 23. The laser beam 201 emitted from the emitter 211 is enlarged by the lens 212 and emitted from the light source 21. A beam 202 emitted from the light source 21 travels toward the modulation portion 230 of the spatial light modulator 23.

The spatial light modulator 23 has the same configuration as the spatial light modulator 13 of the first example embodiment. The spatial light modulator 23 includes a modulation portion 230 irradiated with the beam 202. The modulation portion 230 of the spatial light modulator 23 is irradiated with the beam 202 emitted from the light source 21. In the modulation portion 230 of the spatial light modulator 23, a pattern according to an image to be displayed by a projection beam 205 is set according to the control of the control unit 27. The modulated beam 203 modulated by the modulation portion 230 of the spatial light modulator 23 travels toward a reflective surface 260 of the folding mirror 26.

The shield 24 has the same configuration as the shield 14 of the first example embodiment. The shield 24 is disposed between the spatial light modulator 23 and the folding mirror 26. In other words, the shield 24 is disposed on an optical path of the modulated beam 203 modulated by the modulation portion 230 of the spatial light modulator 23. The shield 24 is an aperture in which a slit-shaped opening is formed in a portion through which light forming a desired image passes. The shield 24 allows light forming a desired image to pass therethrough and shields an unnecessary light component. For example, the shield 24 shields 0th-order light or a ghost included in the modulated beam 203.

The folding mirror 26 is disposed on the optical path of the modulated beam 203. The folding mirror 26 has a planar reflective surface 260. In other words, the folding mirror 26 is a flat mirror. The reflective surface 260 of the folding mirror 26 is disposed toward the opening of the shield 24 and the reflective surface 250 of the curved mirror 25. The folding mirror 26 reflects the modulated beam 203 arriving through the opening of the shield 24 toward the reflective surface 250 of the curved mirror 25. The 0th-order light or the ghost image included in the modulated beam 203 is shielded by the shield 24 and does not reach the reflective surface 260 of the folding mirror 26. That is, the modulated beam 203 reflected by the reflective surface 260 of the folding mirror 26 is constituted by light components that form a desired image.

The curved mirror 25 has the same configuration as the curved mirror 15 of the first example embodiment. The curved mirror 25 is a reflecting mirror having a curved reflective surface 250. The reflective surface 250 of the curved mirror 25 has a curvature in accordance with a projection angle of a projection beam 205. In the example of FIG. 15, the reflective surface 250 of the curved mirror 25 has a shape like a side surface of a cylinder.

The curved mirror 25 is disposed on an optical path of light reflected by the reflective surface 260 of the folding mirror 26, with the reflective surface 250 facing the reflective surface 260 of the folding mirror 26. The reflective surface 250 of the curved mirror 25 is irradiated with a light component reflected by the reflective surface 260 of the folding mirror 26 out of the modulated beam 203 that has been modulated by the modulation portion 230 of the spatial light modulator 23 and has passed through the slit-shaped opening of the shield 24.

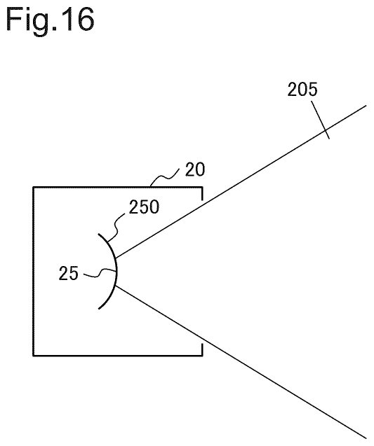

FIG. 16 is a conceptual diagram illustrating an example of a projection range of the light (the projection beam 205) reflected by the reflective surface 250 of the curved mirror 25. FIG. 16 is a view of the internal configuration of the projection device 20 as viewed from above. In FIG. 16, the components other than the curved mirror 25 are omitted. The projection beam 205 reflected by the reflective surface 250 of the curved mirror 25 is projected after being enlarged at an enlargement ratio according to a curvature of the reflective surface 250. In FIG. 16, the projection beam 205 is enlarged along the horizontal direction (the vertical direction of the paper surface of FIG. 16) according to the curvature of the irradiation range of the modulated beam 203 on the reflective surface 250 of the curved mirror 25.

As described above, the projection device according to the present example embodiment includes a light source, a spatial light modulator, a shield, a folding mirror, and a curved mirror. The light source emits a beam. The spatial light modulator includes a modulation portion irradiated with the beam emitted from the light source. The spatial light modulator modulates a phase of the emitted beam in the modulation portion. The control unit sets a phase image for forming a desired image in the modulation portion of the spatial light modulator. The control unit controls the light source in such a way that the modulation portion, in which the phase image is set, is irradiated with the beam. The shield (also referred to as a first shield) is disposed between the spatial light modulator and the curved mirror. The first shield has a slit opened to allow the modulated beam forming the desired image to pass therethrough, and shields an unnecessary light component included in the modulated beam. The folding mirror reflects the optical path of the modulated beam modulated by the modulation portion of the spatial light modulator toward the reflective surface of the curved mirror. The curved mirror has a curved reflective surface irradiated with the modulated beam reflected by the reflective surface of the folding mirror. The curved mirror reflects the modulated beam on the reflective surface, and projects a projection beam having a projection angle enlarged according to a curvature of the reflective surface.

In the configuration of the present example embodiment, the optical path between the spatial light modulator and the curved mirror is folded using the folding mirror. Therefore, according to the configuration of the present example embodiment, it is not necessary to linearly set the optical path between the spatial light modulator and the curved mirror, making it possible to configure the size of the device compactly.

### Third Example Embodiment

Next, a projection device according to a third example embodiment will be described with reference to the drawings. The projection device according to the present example embodiment is different from those in the first and second example embodiments in that modulated beams modulated by the modulation portion of the spatial light modulator are projected in two different directions.

### (Configuration)

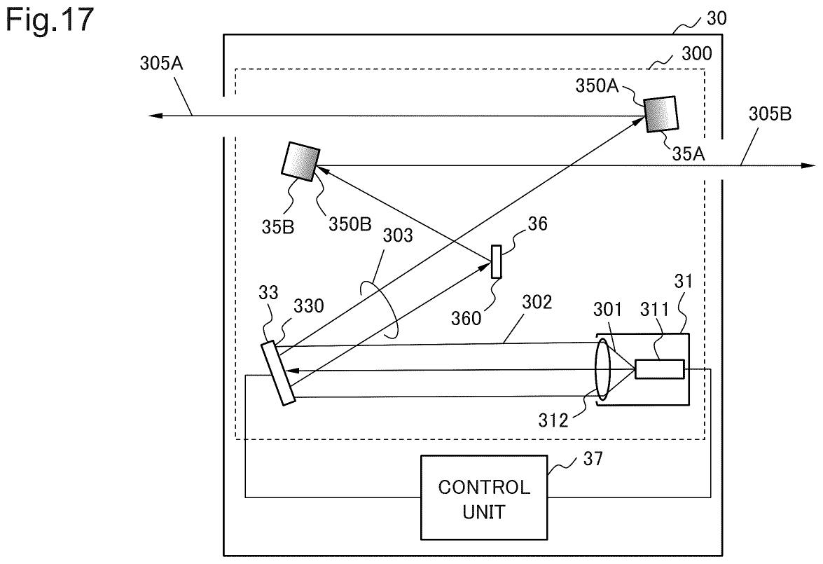

FIG. 17 is a conceptual diagram illustrating an example of a configuration of a projection device 30 according to the present example embodiment. The projection device 30 includes a light source 31, a spatial light modulator 33, a first curved mirror 35A, a second curved mirror 35B, a folding mirror 36, and a control unit 37. The light source 31, the spatial light modulator 33, the first curved mirror 35A, the second curved mirror 35B, and the folding mirror 36 constitute a projection unit 300. FIG. 17 is a side view of an internal configuration of the projection device 30 as viewed from the side. FIG. 17 is conceptual, and does not accurately indicate a positional relationship between the components, a traveling direction of light, etc. Note that, although no shield is illustrated in the configuration of FIG. 17, a shield may be added as in the first and second example embodiments.

The light source 31 has the same configuration as the light source 11 of the first example embodiment. The light source 31 includes an emitter 311 and a lens 312. The emitter 311 emits a laser beam 301 in a predetermined wavelength band under the control of control unit 37. The lens 312 enlarges the laser beam 301 emitted from the emitter 311 in accordance with a size of a modulation portion 330 of the spatial light modulator 33. The laser beam 301 emitted from the emitter 311 is enlarged by the lens 312 and emitted from the light source 31. A beam 302 emitted from the light source 31 travels toward the modulation portion 330 of the spatial light modulator 33.

The spatial light modulator 33 has the same configuration as the spatial light modulator 13 of the first example embodiment. The spatial light modulator 33 includes a modulation portion 330 irradiated with the beam 302. The modulation portion 330 of the spatial light modulator 33 is irradiated with the beam 302 emitted from the light source 31. In the modulation portion 330 of the spatial light modulator 33, a pattern according to an image to be displayed by a projection beam 305 is set according to the control of the control unit 37. A modulated beam 303 modulated by the modulation portion 330 of the spatial light modulator 33 travels toward a reflective surface 350A of the first curved mirror 35A and a reflective surface 360 of the folding mirror 36.

The first curved mirror 35A has the same configuration as the curved mirror 15 of the first example embodiment. The first curved mirror 35A is a reflecting mirror having a curved reflective surface 350A. The reflective surface 350A of the first curved mirror 35A has a curvature in accordance with a projection angle of a projection beam 305A. In the example of FIG. 17, the reflective surface 350A of the first curved mirror 35A has a shape like a side surface of a cylinder.

The first curved mirror 35A is disposed on an optical path of the modulated beam 303, with the reflective surface 350A facing the modulation portion 330 of the spatial light modulator 33. A first optical path is formed between the light source 31, the modulation portion 330 of the spatial light modulator 33, and the reflective surface 350A of the first curved mirror 35A. The reflective surface 350A of the first curved mirror 35A is irradiated with the modulated beam 303 modulated by the modulation portion 330 of the spatial light modulator 33. The light (the projection beam 305A) reflected by reflective surface 350A of the first curved mirror 35A is projected in a first direction (the left direction of the paper surface of FIG. 17), after being enlarged at an enlargement ratio according to a curvature of the reflective surface 350A. In the example of FIG. 17, the projection beam 305A is enlarged along the horizontal direction (the direction perpendicular to the paper surface of FIG. 17) according to the curvature of the reflective surface 350A of the first curved mirror 35A in the irradiation range of the modulated beam 303.

The folding mirror 36 is disposed on an optical path of the modulated beam 303 with the reflective surface 360 facing the modulation portion 330 of the spatial light modulator 33. The folding mirror 36 has a planar reflective surface 360. In other words, the folding mirror 36 is a flat mirror. The reflective surface 360 of the folding mirror 36 is disposed toward the modulation portion 330 of the spatial light modulator 33 and a reflective surface 350B of the second curved mirror 35B. The reflective surface 360 of the folding mirror 36 is irradiated with a light component emitted toward the reflective surface of the folding mirror 36 out of the modulated beam 303 modulated by the modulation portion 330 of the spatial light modulator 33. A light component emitted toward the first curved mirror 35A out of the modulated beam 303 does not reach the reflective surface 360 of the folding mirror 36. The modulated beam 303 reflected by the reflective surface 360 of the folding mirror 36 is constituted by a light component to be reflected by the reflective surface 350B of the second curved mirror 35B and projected as a projection beam 305B in a second direction (the right direction of the paper surface of FIG. 17). For example, in a case where the projection beam is not enlarged using the curved mirror, the first curved mirror 35A and the second curved mirror 35B may be omitted, and only the light in the Fraunhofer region may be used. In that case, the spatial light modulator 33 and the folding mirror 36 may be disposed in such a way that some of the light components of the modulated beam 303 modulated by the modulation portion 330 of the spatial light modulator 33 are projected as they are, and the other light components are projected after being reflected by the reflective surface 360 of the folding mirror 36.

The second curved mirror 35B is disposed on an optical path of light reflected by the reflective surface 360 of the folding mirror 36, with the reflective surface 350B facing the reflective surface 360 of the folding mirror 36. A second optical path is formed between the light source 31, the modulation portion 330 of the spatial light modulator 33, the reflective surface 360 of the folding mirror 36, and the reflective surface 350B of the second curved mirror 35B. The first optical path and the second optical path are preferably set to have the same optical path length. The reflective surface 350B of the second curved mirror 35B is irradiated with a light component reflected by the reflective surface 360 of the folding mirror 36 out of the modulated beam 303 modulated by the modulation portion 330 of the spatial light modulator 33.

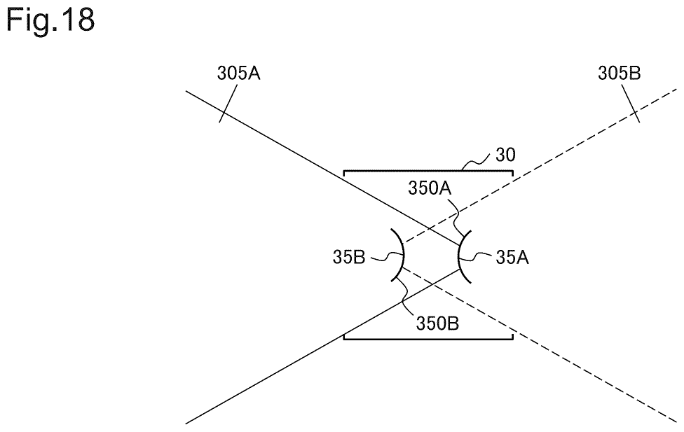

FIG. 18 is a conceptual diagram illustrating examples of a projection range of light (the projection beam 305A) reflected by the reflective surface 350A of the first curved mirror 35A and a projection range of light (the projection beam 305B) reflected by the reflective surface 350B of the second curved mirror 35B. FIG. 18 is a view of the internal configuration of the projection device 30 as viewed from above. In FIG. 18, the components other than the first curved mirror 35A and the second curved mirror 35B are omitted. The projection beam 305A (solid line) reflected by the reflective surface 350A of the first curved mirror 35A is projected after being enlarged at an enlargement ratio according to a curvature of the reflective surface 350A. The projection beam 305B (broken line) reflected by the reflective surface 350B of the second curved mirror 35B is projected after being enlarged at an enlargement ratio according to a curvature of the reflective surface 350B.

In the example of FIG. 18, the projection beam 305A reflected by the reflective surface 350A of the first curved mirror 35A is projected in the first direction (the left direction of the paper surface of FIG. 18). The projection beam 305B reflected by the reflective surface 350B of the second curved mirror 35B is projected in the second direction (the right direction of the paper surface of FIG. 17). For example, the first direction and the second direction are set to diametrically opposite directions. For example, the first direction and the second direction may be set to directions that are not diametrically opposite.

As described above, the projection device according to the present example embodiment includes a light source, a spatial light modulator, a shield, a folding mirror, and a curved mirror. The light source emits a beam. The spatial light modulator includes a modulation portion irradiated with the beam emitted from the light source. The spatial light modulator modulates a phase of the emitted beam in the modulation portion. The control unit sets a phase image for forming a desired image in the modulation portion of the spatial light modulator. The control unit controls the light source in such a way that the modulation portion, in which the phase image is set, is irradiated with the beam. The shield (also referred to as a first shield) is disposed between the spatial light modulator and the curved mirror. The first shield has a slit opened to allow the modulated beam forming the desired image to pass therethrough, and shields an unnecessary light component included in the modulated beam. The curved mirror includes a first curved mirror and a second curved mirror. The first curved mirror has a curved first reflective surface irradiated with a part of the modulated beam modulated by the modulation portion of the spatial light modulator. The first curved mirror reflects the modulated beam on the first reflective surface, and projects a first projection beam having a projection angle enlarged according to a curvature of the first reflective surface. The folding mirror reflects a light component that is not reflected by the first reflective surface of the first curved mirror, out of the modulated beam modulated by the modulation portion of the spatial light modulator, toward the second reflective surface of the second curved mirror. The second curved mirror has a curved second reflective surface irradiated with a light component reflected by the folding mirror out of the modulated beam modulated by the modulation portion of the spatial light modulator. The second curved mirror reflects the light component on the second reflective surface, and projects a second projection beam having a projection angle enlarged according to a curvature of the second reflective surface. The first curved mirror and the second curved mirror are disposed in such a way that the first projection beam and the second projection beam are projected in different directions. For example, the first curved mirror and the second curved mirror are disposed in such a way that the first projection beam and the second projection beam are projected in opposite directions.

In the configuration of the present example embodiment, the projection beam reflected by the reflective surface of the first curved mirror is projected in the first direction. The projection beam reflected by the reflective surface of the second curved mirror is projected in the second direction. Therefore, according to the configuration of the present example embodiment, the projection angles can be expanded to opposing projection directions while having a compact configuration. For example, in the configuration of the present example embodiment, if the projection angle of each of the first curved mirror and the second curved mirror is set to 180 degrees, the projection beam can be projected in a direction of 360 degrees.

### Fourth Example Embodiment

Next, a projection device according to a fourth example embodiment will be described with reference to the drawings. The projection device according to the present example embodiment includes a plurality of light sources. The configuration of the present example embodiment may be combined with those of the second and third example embodiments.

### (Configuration)

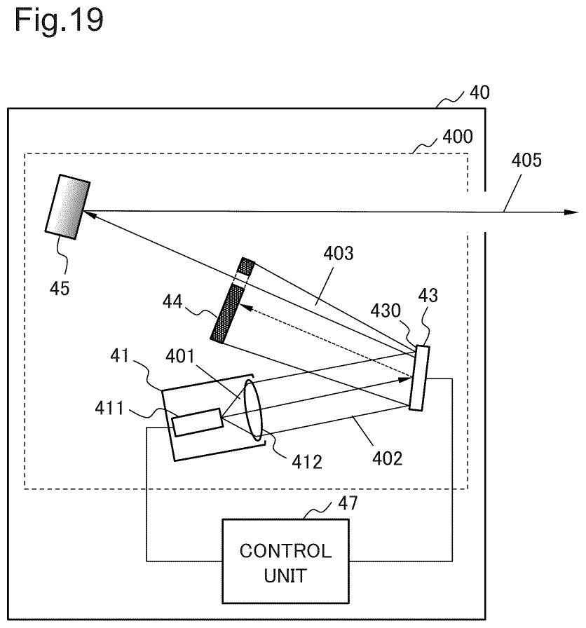

FIG. 19 is a conceptual diagram illustrating an example of a configuration of a projection device 40 according to the present example embodiment. The projection device 40 includes a plurality of light sources 41, a spatial light modulator 43, a shield 44, a curved mirror 45, and a control unit 47. The plurality of light sources 41, the spatial light modulator 43, the shield 44, and the curved mirror 45 constitute a projection unit 400. FIG. 19 is a view of an internal configuration of the projection device 40 as viewed from the side. Although only one light source 41 is illustrated in FIG. 19, a plurality of light sources 41 are arranged in a direction perpendicular to the paper surface. FIG. 19 is conceptual, and does not accurately indicate a positional relationship between the components, a traveling direction of light, etc.

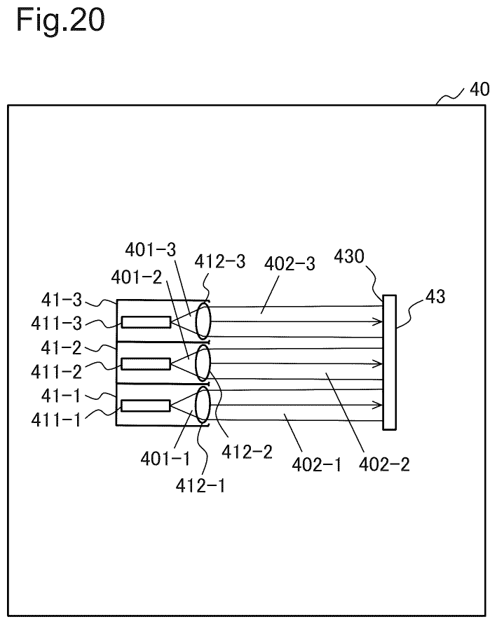

Each of the plurality of light sources 41 has the same configuration as the light source 11 of the first example embodiment. FIG. 20 is a conceptual diagram illustrating an example of a positional relationship between the plurality of light sources 41-1 to 41-3 arranged inside the projection device 40 and the spatial light modulator 43. The light sources 41-1 to 41-3 include emitters 411-1 to 411-3 and lenses 412-1 to 412-3. Although it is exemplified in the present example embodiment that the projection device 40 includes three light sources 41-1 to 41-3, the number of light sources 41 included in the projection device 40 is not limited to three.

The emitters 411-1 to 411-3 emit laser beams 401-1 to 401-3 in a predetermined wavelength band under the control of the control unit 47. The emitters 411-1 to 411-3 may be configured to emit laser beams 401-1 to 401-3 in the same wavelength band, or may be configured to emit laser beams 401-1 to 401-3 in different wavelength bands. Further, the emitters 411-1 to 411-3 may be configured to emit laser beams 401-1 to 401-3 having the same output, or may be configured to emit laser beams 401-1 to 401-3 having different outputs. The wavelength bands and outputs of the laser beams 401-1 to 401-3 emitted from the emitters 411-1 to 411-3 may be selected according to the application.

The lenses 412-1 to 412-3 enlarge the laser beams 401-1 to 401-3 emitted from the emitters 411-1 to 411-3 according to sizes of regions set for the laser beams 401-1 to 401-3, respectively, in the modulation portion 430 of the spatial light modulator 43. The laser beams 401-1 to 401-3 emitted from the emitters 411-1 to 411-3 are enlarged by the lenses 412-1 to 412-3 and emitted from the light sources 41-1 to 41-3. Beams 402-1 to 402-3 emitted from the light sources 41-1 to 41-3 travel toward the modulation portion 430 of the spatial light modulator 43.

The spatial light modulator 43 has the same configuration as the spatial light modulator 13 of the first example embodiment. The spatial light modulator 43 includes a modulation portion 430 irradiated with the beams 402-1 to 402-3. The modulation portion 430 is divided into a plurality of regions each allocated for one of the beams 402-1 to 402-3. Each of the plurality of regions of the modulation portion 430 of the spatial light modulator 43 is irradiated with an allocated beam 402 among the beams 402-1 to 402-3 emitted from the light sources 41-1 to 41-3. In the modulation portion 430 of the spatial light modulator 43, a pattern according to an image to be displayed by a projection beam 406 is set to a region for each of the beams 402-1 to 402-3 under the control of the control unit 47.

The shield 44 has the same configuration as the shield 14 of the first example embodiment. The shield 44 is disposed between the spatial light modulator 43 and the curved mirror 45. In other words, the shield 44 is disposed on an optical path of a modulated beam 403 modulated by the modulation portion 430 of the spatial light modulator 43. The shield 44 is an aperture in which a slit-shaped opening is formed in a portion through which light forming a desired image passes. The shield 44 allows light forming a desired image to pass therethrough and shields an unnecessary light component. For example, the shield 44 shields 0th-order light or a ghost included in the modulated beam 403.

The curved mirror 45 has the same configuration as the curved mirror 15 of the first example embodiment. The curved mirror 45 is a reflecting mirror having a curved reflective surface 450. The reflective surface 450 of the curved mirror 45 has a curvature in accordance with a projection angle of a projection beam 405. In the example of FIG. 19, the reflective surface 450 of the curved mirror 45 has a shape like a side surface of a cylinder.

The curved mirror 45 is disposed on an optical path of the modulated beam 403 modulated by the modulation portion 430 of the spatial light modulator 43, with the reflective surface 450 facing the spatial light modulator 43. The reflective surface 450 of the curved mirror 45 is irradiated with the modulated beam 403 that has been modulated by the modulation portion 430 of the spatial light modulator 43 and has passed through the slit-shaped opening of the shield 44.

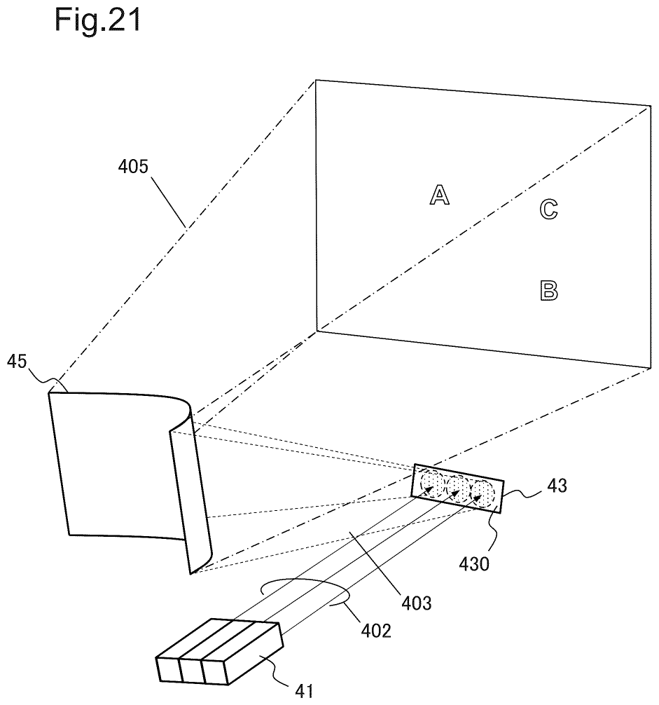

FIG. 21 is a conceptual diagram illustrating an example in which light (the projection beam 405) reflected by the reflective surface 450 of the curved mirror 45 is projected. FIG. 21 is a view of the internal configuration of projection device 40 as the curved mirror 45 is looked down at. The projection beam 405 derived from the modulated beam 403 reflected by the reflective surface 450 of the curved mirror 45 is projected after being enlarged at an enlargement ratio according to a curvature of the reflective surface 450. The projection beam 405 is projected in a direction according to a position where the modulated beam 403 is irradiated on the reflective surface 450. The projection beam 405 displays an image corresponding to the phase image set in the modulation portion 130 of the spatial light modulator 13 at a certain position on the projection surface.

As described above, a projection device according to the present example embodiment includes a light source, a spatial light modulator, a shield, and a curved mirror. The light source includes a plurality of emitters and a plurality of lenses that enlarge beams emitted by the plurality of emitters, respectively, in accordance with a size of the modulation portion of the spatial light modulator. The spatial light modulator includes a modulation portion irradiated with the beam emitted from the light source. The spatial light modulator modulates a phase of the emitted beam in the modulation portion. The control unit sets a phase image for forming a desired image in the modulation portion of the spatial light modulator. The control unit controls the light source in such a way that the modulation portion, in which the phase image is set, is irradiated with the beam. The shield (also referred to as a first shield) is disposed between the spatial light modulator and the curved mirror. The first shield has a slit opened to allow the modulated beam forming the desired image to pass therethrough, and shields an unnecessary light component included in the modulated beam. The curved mirror has a curved reflective surface irradiated with the modulated beam modulated by the modulation portion of the spatial light modulator. The curved mirror reflects the modulated beam on the reflective surface, and projects a projection beam having a projection angle enlarged according to a curvature of the reflective surface.

The projection device according to the present example embodiment includes a plurality of light sources. Therefore, according to the present example embodiment, desired images can be simultaneously projected toward different projection targets. For example, according to the present example embodiment, projection beams of a plurality of wavelength bands and spatial light signals directed to a plurality of communication targets can be simultaneously projected. For example, according to the present example embodiment, it is possible to simultaneously project a spatial light signal for scanning a communication target and a spatial light signal for communicating with a communication target with which communication has been established.

### Fifth Example Embodiment

Next, a communication device according to a fifth example embodiment will be described with reference to the drawings. The communication device according to the present example embodiment includes the projection device according to any one of the first to fourth example embodiments and a projection device that projects a spatial light signal. Hereinafter, an example of a communication device including a projection device including a phase modulation-type spatial light modulator will be described. Note that the communication device according to the present example embodiment may include a projection device having a light transmission function rather than the phase modulation-type spatial light modulator.

### (Configuration)

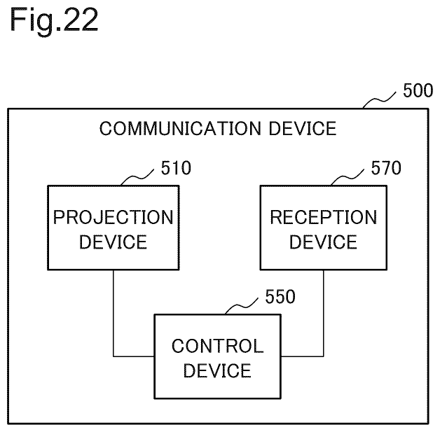

FIG. 22 is a conceptual diagram illustrating an example of a configuration of a communication device 500 according to the present example embodiment. The communication device 500 includes a projection device 510, a control device 550, and a reception device 570. The projection device 510 and the reception device 570 transmit and receive spatial light signals to and from an external communication target. Therefore, an opening or a window for transmitting and receiving spatial light signals is formed in the communication device 500.

The projection device 510 is the projection device according to any one of the first to fourth example embodiments. The projection device 510 acquires a control signal from the control device 550. The projection device 510 projects a spatial light signal according to the control signal. The spatial light signal projected from the projection device 510 is received by a communication target (not illustrated).

The control device 550 acquires a signal output from the reception device 570. The control device 550 executes processing according to the acquired signal. The processing executed by the control device 550 is not particularly limited. The control device 550 outputs a control signal for projecting a light signal according to the executed processing to the projection device 510.

The reception device 570 receives a spatial light signal projected from a communication target (not illustrated). The reception device 570 converts the received spatial light signal into an electrical signal. The reception device 570 outputs the converted electric signal to the control device 550.

### [Reception Device]

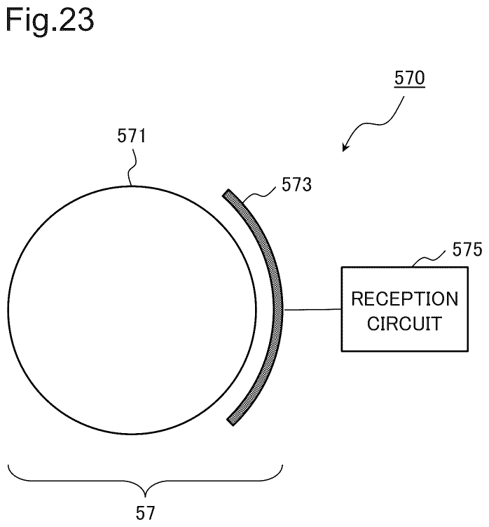

Next, an example of a detailed configuration of the reception device will be described with reference to the drawings. FIG. 23 is a conceptual diagram illustrating an example of a detailed configuration of the reception device 570 according to the present example embodiment. The reception device 570 includes a ball lens 571, a light receiving element array 573, and a reception circuit 575. The ball lens 571 and the light receiving element array 573 constitute a light receiver 57.

The ball lens 571 is a spherical lens. The ball lens 571 is an optical element that condenses a spatial light signal arriving from the outside. The ball lens 571 is spherical when viewed at any angle. The ball lens 571 condenses a spatial light signal incident thereon. Light (also referred to as a light signal) derived from the spatial light signal condensed by the ball lens 571 is condensed toward a condensing region. Since the ball lens 571 has a spherical shape, the ball lens 571 condenses a spatial light signal arriving from any direction. That is, the ball lens 571 exhibits similar light condensing performances for spatial light signals arriving from any directions.

For example, the ball lens 571 can be made of a material such as glass, crystal, or resin. In a case where a spatial light signal in the visible region is received, the material such as glass, crystal, or resin that transmits/refracts light in the visible region can be applied to the ball lens 571. For example, optical glass such as crown glass or flint glass can be applied to the ball lens 571. For example, crown glass such as Boron Kron (BK) can be applied to the ball lens 571. For example, flint glass such as Lanthanum Schwerflint (LaSF) can be applied to the ball lens 571. For example, quartz glass can be applied to the ball lens 571. For example, crystal such as sapphire can be applied to the ball lens 571. For example, transparent resin such as acryl can be applied to the ball lens 571. In a case where the spatial light signal is light in a near-infrared region (hereinafter also referred to as near-infrared light), a material capable of transmitting near-infrared light is used for the ball lens 571. For example, in a case where a spatial light signal in a near-infrared region of about 1.5 micrometers (μm), a material such as silicon can be applied to the ball lens 571 in addition to glass, crystal, resin, or the like. In a case where the spatial light signal is light in an infrared region (hereinafter also referred to as infrared light), a material capable of transmitting infrared light is used for the ball lens 571. For example, in a case where the spatial light signal is infrared light, a silicon, germanium, or chalcogenide material can be applied to the ball lens 571. The material of the ball lens 571 is not limited as long as it is capable of transmitting/refracting light in the wavelength region of the spatial light signal. The material of the ball lens 571 may be selected according to the required refractive index and application.

The light receiving element array 573 includes a plurality of light receiving elements arranged in an arc shape along the circumferential direction of the ball lens 571. The number of light receiving elements constituting the light receiving element array 573 is not limited. The light receiving element array 573 is disposed at a stage after the ball lens 571. Each of the plurality of light receiving elements includes a light receiving portion that receives a light signal derived from a spatial light signal to be received. Each of the plurality of light receiving elements is disposed in such a way that the light receiving portion faces an emission surface of the ball lens 571. Each of the plurality of light receiving elements is disposed in such a way that the light receiving portion is located in the condensing region of the ball lens 571. The light signal condensed by the ball lens 571 is received by the light receiving portion of the light receiving element located in the condensing region.

The light receiving element receives light in a wavelength region of the spatial light signal to be received. For example, the light receiving element is sensitive to light in the visible region. For example, the light receiving element is sensitive to light in the infrared region. The light receiving element is sensitive to light having a wavelength, for example, in the 1.5 μm (micrometer) band. Note that the wavelength band of the light to which the light receiving element is sensitive is not limited to the 1.5 μm band. The wavelength band of light received by the light receiving element can be set in accordance with a wavelength of a spatial light signal projected from a projection device (not illustrated). The wavelength band of the light received by the light receiving element may be set to, for example, a 0.8 μm band, a 1.55 μm band, or a 2.2 μm band. Alternatively, the wavelength band of the light received by the light receiving element may be, for example, a 0.8 to 1 μm band. The shorter the wavelength band, the smaller the absorption by moisture in the atmosphere, which is advantageous for optical spatial communication during rainfall. In addition, if saturated with intense sunlight, the light receiving element is not capable of reading a light signal derived from a spatial light signal. Therefore, a color filter that selectively passes light in the wavelength band of the spatial light signal may be installed at a stage before the light receiving element.

For example, the light receiving element can be achieved by an element such as a photodiode or a phototransistor. For example, the light receiving element is achieved by an avalanche photodiode. The light receiving element achieved by the avalanche photodiode is capable of supporting high-speed communication. Note that the light receiving element may be achieved by an element other than the photodiode, the phototransistor, or the avalanche photodiode as long as it is capable of converting a light signal into an electric signal. In order to improve the communication speed, the light receiving portion of the light receiving element is preferably as small as possible. For example, the light receiving portion of the light receiving element has a square light receiving surface having a side of about 5 millimeters (mm). For example, the light receiving portion of the light receiving element has a circular light receiving surface having a diameter of about 0.1 to 0.3 mm. The size and shape of the light receiving portion of the light receiving element may be selected according to the wavelength band of the spatial light signal, the communication speed, and the like.

The light receiving element converts the received light signal into an electric signal. The light receiving element outputs the converted electric signal to the reception circuit 575. Although only one line (path) is illustrated between the light receiving element array 573 and the reception circuit 575 in FIG. 23, the light receiving element array 573 and the reception circuit 575 may be connected to each other by a plurality of paths. For example, each of the light receiving elements constituting the light receiving element array 573 may be individually connected to the reception circuit 575. For example, each group of light receiving elements constituting the light receiving element array 573 may be connected to the reception circuit 575.

The reception circuit 575 acquires a signal output from each of the plurality of light receiving elements. The reception circuit 575 amplifies the signal from each of the plurality of light receiving elements. The reception circuit 575 decodes the amplified signal and analyzes the signal from the communication target. For example, the reception circuit 575 collectively analyzes signals for the plurality of light receiving elements. In a case where signals are analyzed collectively for the plurality of light receiving elements, it is possible to achieve a single-channel reception device 570 that communicates with a single communication target. For example, the reception circuit 575 individually analyzes a signal for each of the plurality of light receiving elements. In a case where a signal is individually analyzed for each of a plurality of light receiving elements, it is possible to realize the multi-channel reception device 570 that communicates with a plurality of communication targets simultaneously. The signal decoded by the reception circuit 575 is used for any purpose. The use of the signal decoded by the reception circuit 575 is not particularly limited.

The reception device 570 according to the present example embodiment receives a light signal condensed by the ball lens 571 through a plurality of reception elements. The ball lens 571 uniformly condenses a spatial light signal arriving from any direction on the surrounding condensing region. Therefore, according to the present example embodiment, a light signal arriving from various directions can be uniformly received with a simple configuration.

For example, the reception device 570 has a configuration in which a plurality of reception elements are arranged in an annular shape in the condensing region of the ball lens 571. The ball lens 571 condenses a light signal arriving from a certain direction substantially parallel to the plane including the ring formed by the plurality of light receiving elements on the condensing region. Since the plurality of reception elements are annularly arranged in the condensing region of the ball lens 571, it is possible to receive a spatial light signal arriving from any direction. That is, if a plurality of reception elements are arranged in an annular shape in the condensing region of the ball lens 571, it is possible to receive a spatial light signal arriving from a direction of 360 degrees. For example, the projection device 30 according to the second example embodiment configured to project a projection beam in a direction of 360 degrees and the reception device 570 including the light receiving element array 573 constituted by a plurality of reception elements arranged in an annular shape are combined together. With such a configuration, it is possible to achieve a communication device that projects a spatial light signal in a direction of 360 degrees and receives a spatial light signal arriving from a direction of 360 degrees.

### Example of Application

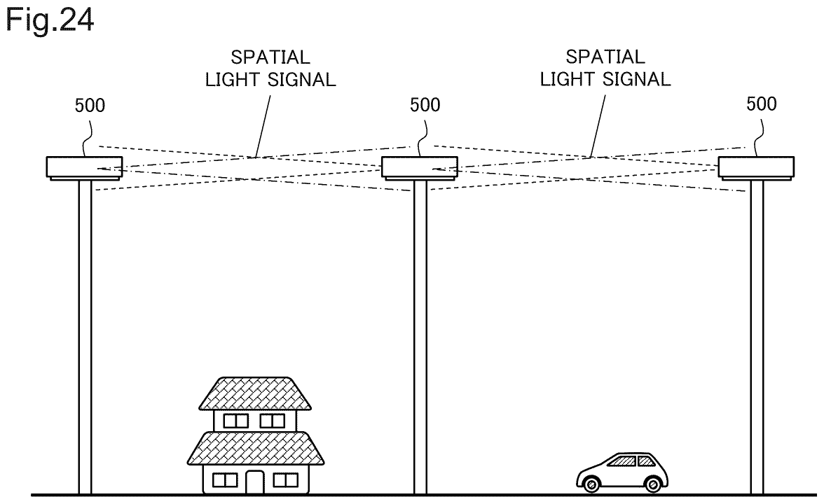

Next, an example in which the communication device 500 according to the present example embodiment is applied will be described with reference to the drawings. FIG. 24 is a conceptual diagram for explaining the present application example. In the present example of application, a communication network is configured by arranging a plurality of communication devices 500 at the tops of poles such as utility poles or street lamps. The plurality of communication devices 500 performs bidirectional communication using spatial light signals.

There are few obstacles at the tops of poles such as utility poles or street lamps. Therefore, the tops of poles such as utility poles or street lamps are suitable for installing the communication device 500. In addition, if the communication devices 500 are installed at the same height the tops of poles, an arrival direction of a spatial light signal is limited to the horizontal direction, so that the light receiving area of the light receiving element array 573 constituting the light receiver 57 can be reduced and the device can be simplified. The pair of communication devices 500 that communicate with each other are arranged in such a way that at least one communication device 500 receives a spatial light signal projected from any of the communication devices 500. The pair of communication devices 500 may be arranged to transmit and receive spatial light signals to and from each other. In a case where a communication network for spatial light signals is configured by the plurality of communication devices 500, the communication device 500 positioned in the middle may be disposed to relay a spatial light signal projected from another communication device 500 to another communication device 500.

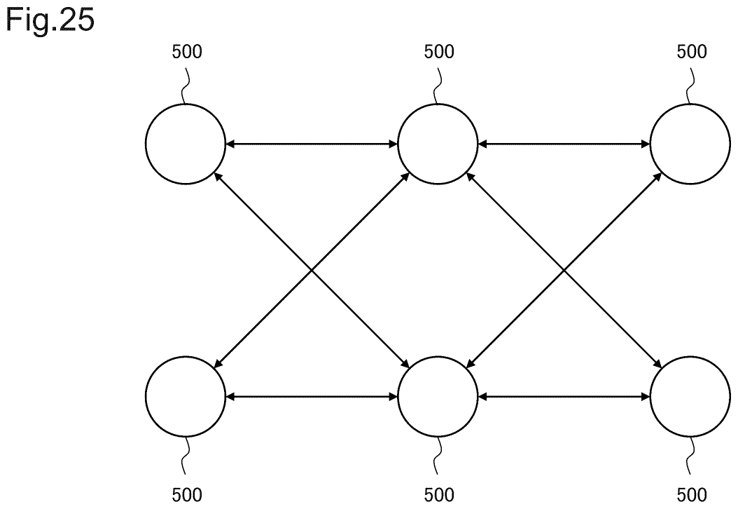

FIG. 25 is a conceptual diagram illustrating an example of a communication network formed by arranging a plurality of communication devices 500 in a mesh shape. For example, as illustrated in FIG. 25, the plurality of communication devices 500 are arranged at the tops of poles such as utility poles or street lamps. In FIG. 25, communication paths formed between the plurality of communication devices 500 are indicated by arrows. In the example of FIG. 25, the plurality of communication devices 500 perform bidirectional communication by transmitting and receiving spatial light signals.

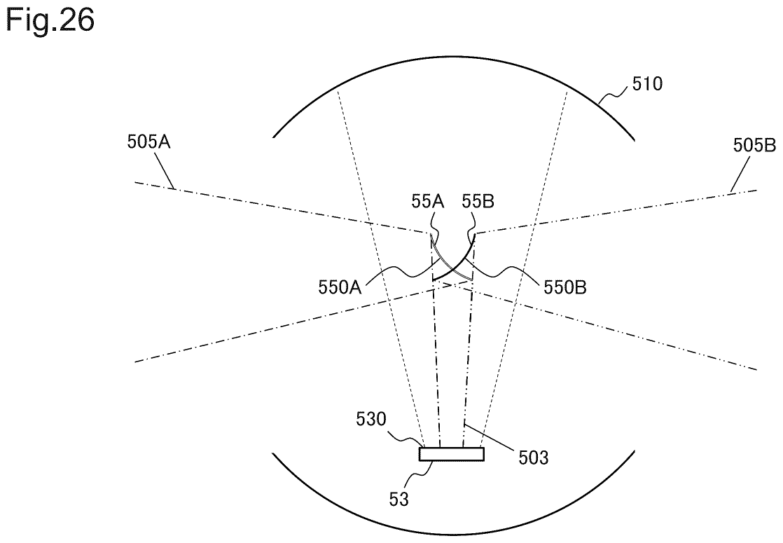

FIG. 26 is a conceptual diagram illustrating an example of a configuration of a projection device 510 used in the communication device 500 forming the mesh-like communication network. The projection device 510 includes a light source (not illustrated), a lens (not illustrated), a spatial light modulator 53, a first curved mirror 55A, and a second curved mirror 55B. The first curved mirror 55A and the second curved mirror 55B are arranged to be shifted from each other in the vertical direction (the vertical direction of the paper surface of FIG. 26). One of the first curved mirror 55A and the second curved mirror 55B is disposed above and the other one is disposed below. In FIG. 26, the light source and the lens are omitted. FIG. 26 is a plan view of an internal configuration of the projection device 510 as viewed from above. FIG. 26 is conceptual, and does not accurately indicate a positional relationship between the components, a traveling direction of light, etc.

The first curved mirror 55A is disposed on an optical path of a modulated beam 503, with a reflective surface 550A facing a modulation portion 530 of the spatial light modulator 53. The reflective surface 550A of the first curved mirror 55A is irradiated with the modulated beam 503 modulated near the center of the modulation portion 530 of the spatial light modulator 53. The modulated beam 503 modulated in a peripheral portion of the modulation portion 530 of the spatial light modulator 53 travels to a region deviated from the reflective surface 550A of the first curved mirror 55A. Light (a projection beam 505A) reflected by the reflective surface 550A of the first curved mirror 55A is projected after being enlarged at an enlargement ratio according to a curvature of the reflective surface 550A. In the example of FIG. 26, the projection beam 505A is enlarged along the horizontal direction (the vertical direction of the paper surface of FIG. 26) according to the curvature of the reflective surface 550A of the first curved mirror 55A in the irradiation range of the modulated beam 503, and is emitted toward the first direction (the right direction of the paper surface of FIG. 26). For example, the area, curvature, direction, and the like of the reflective surface 550A of the first curved mirror 55A may be adjusted to widen the projection range of the projection beam 505A. For example, the area, curvature, direction, and the like of the reflective surface 550A of the first curved mirror 55A may be adjusted to change the projection direction of the projection beam 505A.

Similarly, the second curved mirror 55B is disposed on an optical path of the modulated beam 503, with a reflective surface 550B facing the modulation portion 530 of the spatial light modulator 53. The reflective surface 550B of the second curved mirror 55B is irradiated with the modulated beam 503 modulated near the center of the modulation portion 530 of the spatial light modulator 53. The modulated beam 503 modulated in the peripheral portion of the modulation portion 530 of the spatial light modulator 53 travels to a region deviated from the reflective surface 550B of the second curved mirror 55B. Light (a projection beam 505B) reflected by the reflective surface 550B of the second curved mirror 55B is projected after being enlarged at an enlargement ratio according to a curvature of reflective surface 550B. In the example of FIG. 26, the projection beam 505B is enlarged along the horizontal direction (the vertical direction of the paper surface of FIG. 26) according to the curvature of the reflective surface 550B of the second curved mirror 55B in the irradiation range of the modulated beam 503, and is emitted toward the second direction (the left direction of the paper surface of FIG. 26). For example, the area, curvature, direction, and the like of the reflective surface 550B of the second curved mirror 55B may be adjusted to widen the projection range of the projection beam 505B. For example, the area, curvature, direction, and the like of the reflective surface 550B of the second curved mirror 55B may be adjusted to change the projection direction of the projection beam 505B.

According to the present application example, the plurality of communication devices 500 installed on different poles can communicate with each other using spatial light signals. For example, communication may be performed in a wireless manner between a wireless device installed in an automobile, a house, or the like or a base station and a communication device 500 according to communication between the communication devices 500 installed on the different poles. For example, the communication device 500 may be configured to be connected to the Internet via the pole.

As described above, the communication device according to the present example embodiment includes the projection device according to any one of the first to fourth example embodiments, a reception device, and a projection device. The reception device receives a light signal transmitted from another communication device. The reception device decodes a signal based on the received light signal. The control device receives the signal decoded by the reception device. The control device executes processing according to the received signal. The control device transmits a light signal according to the executed processing to the projection device. According to the present example embodiment, it is possible to achieve a communication device that transmits and receives light signals.

### Sixth Example Embodiment

Next, a projection device according to a sixth example embodiment will be described with reference to the drawings. The projection device according to the present example embodiment has a simplified configuration as compared with the projection devices according to the first to fourth example embodiments.

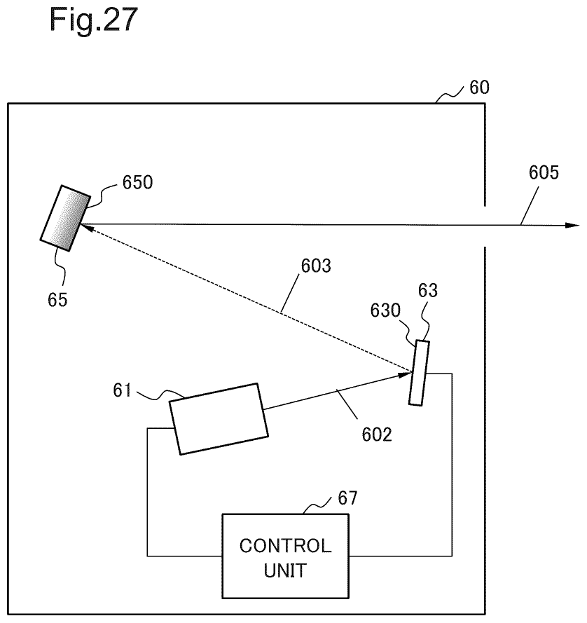

FIG. 27 is a block diagram illustrating an example of a configuration of a projection device 60 according to the present example embodiment. The projection device 60 includes a light source 61, a spatial light modulator 63, a curved mirror 65, and a control unit 67. FIG. 27 is a view of an internal configuration of the projection device 60 as viewed from a lateral perspective.

The light source 61 emits a beam. The spatial light modulator 63 includes a modulation portion 630 irradiated with a beam 602 emitted from the light source 61. The spatial light modulator 63 modulates a phase of the emitted beam 602 in the modulation portion 630. The control unit 67 sets a phase image for forming a desired image in the modulation portion 630 of the spatial light modulator 63. The control unit 67 controls the light source 61 in such a way that the modulation portion 630, in which the phase image is set, is irradiated with the beam 602. The curved mirror 65 has a curved reflective surface 650 irradiated with a modulated beam 603 modulated by the modulation portion 630 of the spatial light modulator 63. The curved mirror 65 reflects the modulated beam 603 on the reflective surface 650, and projects a projection beam 605 having a projection angle enlarged according to a curvature of the reflective surface 650.

As described above, the projection device according to the present example embodiment can project a desired image while having a structure in which a projection optical system such as a projection lens is omitted. That is, the projection device according to the present example embodiment is capable of projecting spatial light forming a desired image with a simple configuration.

### (Hardware)

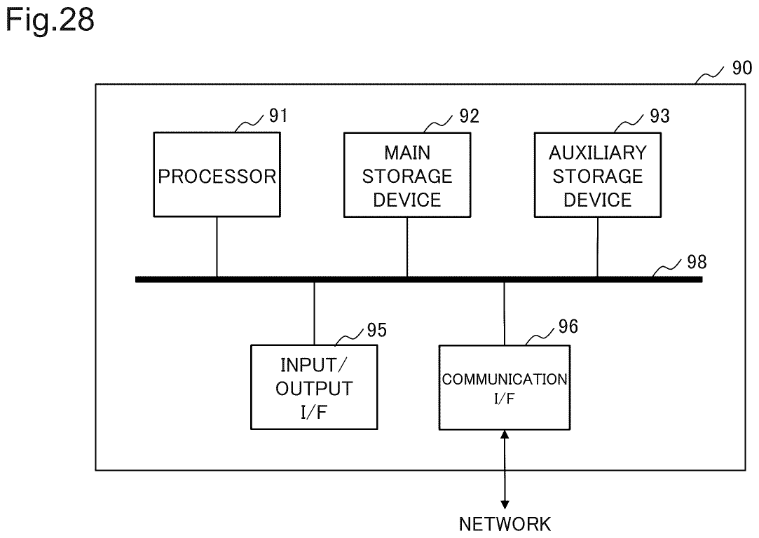

Here, a hardware configuration for executing the control or processing according to each of the above-described example embodiments of the present disclosure will be described using an information processing device 90 of FIG. 28 as an example. Note that the information processing device 90 of FIG. 28 is an example of the configuration for executing the control or processing according to each of the above-described example embodiments, and does not limit the scope of the present disclosure.

As illustrated in FIG. 28, the information processing device 90 includes a processor 91, a main storage device 92, an auxiliary storage device 93, an input/output interface 95, and a communication interface 96. In FIG. 28, an interface is abbreviated as an I/F. The processor 91, the main storage device 92, the auxiliary storage device 93, the input/output interface 95, and the communication interface 96 are connected to each other via a bus 98 for data communication therebetween. In addition, the processor 91, the main storage device 92, the auxiliary storage device 93, and the input/output interface 95 are connected to a network such as the Internet or an intranet via the communication interface 96.

The processor 91 develops a program stored in the auxiliary storage device 93 or the like in the main storage device 92. The processor 91 executes the program developed in the main storage device 92. In the present example embodiment, a software program installed in the information processing device 90 may be used. The processor 91 executes the control or processing according to each of the above-described example embodiments.

The main storage device 92 has an area in which a program is developed. A program stored in the auxiliary storage device 93 or the like is developed in the main storage device 92 by the processor 91. The main storage device 92 is achieved by, for example, a volatile memory such as a dynamic random access memory (DRAM). In addition, a nonvolatile memory such as a magnetoresistive random access memory (MRAM) may be included/added as the main storage device 92.

The auxiliary storage device 93 stores various data such as programs. The auxiliary storage device 93 is achieved by a local disk such as a hard disk or a flash memory. Note that various data may be stored in the main storage device 92, and the auxiliary storage device 93 may be omitted.

The input/output interface 95 is an interface for connecting the information processing device 90 and a peripheral device to each other in accordance with a standard or a specification. The communication interface 96 is an interface for connection to an external system or device through a network such as the Internet or an intranet in accordance with a standard or a specification. The input/output interface 95 and the communication interface 96 may be shared as an interface connected to an external device.

An input device such as a keyboard, a mouse, or a touch panel may be connected to the information processing device 90 if necessary. These input devices are used to input information and settings. In a case where the touch panel is used as an input device, a display screen of a display device may also serve as an interface of the input device. Data communication between the processor 91 and the input device may be mediated by the input/output interface 95.

Furthermore, the information processing device 90 may include a display device for displaying information. In a case where the information processing device 90 includes a display device, the information processing device 90 preferably includes a display control device (not illustrated) for controlling the display of the display device. The display device may be connected to the information processing device 90 via the input/output interface 95.

Furthermore, the information processing device 90 may be equipped with a drive device. Between the processor 91 and the recording medium (program recording medium), the drive device mediates reading of data or a program from the recording medium, writing of a processing result of the information processing device 90 to the recording medium, and the like. The drive device only needs to be connected to the information processing device 90 via the input/output interface 95.

An example of the hardware configuration for enabling the control or processing according to each of the above-described example embodiments of the present disclosure has been described above. Note that the hardware configuration of FIG. 28 is an example of the hardware configuration for executing the control or processing according to each of the above-described example embodiments, and does not limit the scope of the present disclosure. In addition, a program for causing a computer to execute the control or processing according to each of the above-described example embodiments also falls within the scope of the present disclosure. Furthermore, a program recording medium recording the program according to each of the above-described example embodiments also falls within the scope of the present disclosure. The recording medium can be achieved by, for example, an optical recording medium such as a compact disc (CD) or a digital versatile disc (DVD). The recording medium may be achieved by a semiconductor recording medium such as a universal serial bus (USB) memory or a secure digital (SD) card. Furthermore, the recording medium may be achieved by a magnetic recording medium such as a flexible disk, or another recording medium. In a case where a program executed by the processor is recorded in the recording medium, the recording medium is a program recording medium.

The components of the above-described example embodiments may be combined in any manner. In addition, the components according to each of the above-described example embodiments may be achieved by software or by a circuit.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

Some or all of the above-described example embodiments may be described as in the following supplementary notes, but are not limited to the following supplementary notes.

### (Supplementary Note 1)

A projection device including:
a light source;
a spatial light modulator including a modulation portion irradiated with a beam emitted from the light source, the spatial light modulator modulating a phase of the emitted beam in the modulation portion;
a control unit that sets a phase image for forming a desired image in the modulation portion of the spatial light modulator, and controls the light source in such a way that the modulation portion, in which the phase image is set, is irradiated with the beam; and
a curved mirror having a curved reflective surface irradiated with a modulated beam modulated by the modulation portion of the spatial light modulator, the curved mirror reflecting the modulated beam on the reflective surface, and projecting a projection beam having a projection angle enlarged according to a curvature of the reflective surface.

### (Supplementary Note 2)

The projection device according to supplementary note 1, in which the control unit sets, in the modulation portion of the spatial light modulator, a composite image obtained by combining a virtual lens image for condensing the modulated beam forming the desired image on the reflective surface of the curved mirror with the phase image for forming the desired image.

### (Supplementary Note 3)

The projection device according to supplementary note 1 or 2, further including a first shield disposed between the spatial light modulator and the curved mirror, and having a slit opened to allow the modulated beam forming the desired image to pass therethrough, the first shield shielding an unnecessary light component included in the modulated beam.

### (Supplementary Note 4)

The projection device according to supplementary note 1 or 2, further including a second shield disposed on an optical path of the projection beam reflected by the reflective surface of the curved mirror, and having a slit opened to allow the projection beam forming the desired image to pass therethrough, the second shield shielding an unnecessary light component included in the projection beam.

### (Supplementary Note 5)

The projection device according to supplementary note 1 or 2, further including a third shield disposed behind the curved mirror, the third shield shielding an unnecessary light component included in the modulated beam forming the desired image.

### (Supplementary Note 6)

The projection device according to any one of supplementary notes 1 to 5, in which a condensing point for the beam emitted by the light source is set behind the curved mirror.

### (Supplementary Note 7)

The projection device according to any one of supplementary notes 1 to 5, further including a 0th-order light remover that removes 0th-order light included in the modulated beam modulated by the modulation portion of the spatial light modulator, in which
a condensing point for the beam emitted by the light source is set between the spatial light modulator and the curved mirror, and
the 0th-order light remover is disposed at a focal position of the beam.

### (Supplementary Note 8)

The projection device according to any one of supplementary notes 1 to 7, in which the reflective surface of the curved mirror has a curvature in a plane parallel to a horizontal plane.

### (Supplementary Note 9)

The projection device according to any one of supplementary notes 1 to 8, in which the reflective surface of the curved mirror has a curvature in a plane perpendicular to a horizontal plane.

### (Supplementary Note 10)

The projection device according to any one of claims 1 to 9, further including a folding mirror that reflects an optical path of the modulated beam modulated by the modulation portion of the spatial light modulator toward the reflective surface of the curved mirror.

### (Supplementary Note 11)

The projection device according to supplementary note 10, in which
the curved mirror includes a first curved mirror and a second curved mirror,
the first curved mirror has a curved first reflective surface irradiated with a part of the modulated beam modulated by the modulation portion of the spatial light modulator, reflects the modulated beam on the first reflective surface, and projects a first projection beam having a projection angle enlarged according to a curvature of the first reflective surface,
the folding mirror reflects a light component that is not reflected by the first reflective surface of the first curved mirror, out of the modulated beam modulated by the modulation portion of the spatial light modulator, toward the second curved mirror,
the second curved mirror has a curved second reflective surface irradiated with a light component reflected by the folding mirror out of the modulated beam modulated by the modulation portion of the spatial light modulator, reflects the light component on the second reflective surface, and projects a second projection beam having a projection angle enlarged according to a curvature of the second reflective surface, and
the first curved mirror and the second curved mirror are disposed in such a way that the first projection beam and the second projection beam are projected in different directions.

### (Supplementary Note 12)

The projection device according to supplementary note 11, in which the first curved mirror and the second curved mirror are disposed in such a way that the first projection beam and the second projection beam are projected in opposite directions.

### (Supplementary Note 13)

The projection device according to any one of supplementary notes 1 to 12, in which the light source includes:
a plurality of emitters; and
a plurality of lenses that enlarge beams emitted by the plurality of emitters, respectively, according to a size of the modulation portion of the spatial light modulator.

(Supplementary Note 14)

A communication device including:
the projection device according to any one of supplementary notes 1 to 13;
a reception device that receives a light signal transmitted from another communication device, and decodes a signal based on the received light signal; and
a control device that receives the signal decoded by the reception device, executes processing according to the received signal, and transmits a light signal according to the executed processing to the projection device.

### REFERENCE SIGNS LIST

10, 20, 30, 40, 60 Projection device
11, 21, 31, 41, 61 Light source
13, 23, 33, 43, 63 Spatial light modulator
14, 24, 44 Shield
15, 25, 45, 65 Curved mirror
17, 27, 37, 47, 67 Control unit
26, 36 Folding mirror
35A First curved mirror
35B Second curved mirror
111, 211, 311, 411 Emitter
112, 212, 312, 412 Lens
100, 200, 300, 400 Projection unit
500 Communication device
510 Projection device
550 Control device
570 Reception device
571 Ball lens
573 Light receiving element array
575 Reception circuit

What is claimed is:

1. A projection device comprising:
a light source;
a spatial light modulator including a modulation portion irradiated with a beam emitted from the light source, the spatial light modulator being configured to modulate a phase of the emitted beam in the modulation portion;
a controller comprising a first memory storing instructions, and a first processor connected to the first memory and configured to execute the instructions to set a phase image for forming a desired image in the modulation portion of the spatial light modulator, and control the light source in such a way that the modulation portion, in which the phase image is set, is irradiated with the beam; and
a curved mirror having a curved reflective surface irradiated with a modulated beam modulated by the modulation portion of the spatial light modulator, the curved mirror being configured to reflect the modulated beam on the reflective surface, and project a projection beam having a projection angle enlarged according to a curvature of the reflective surface.

2. The projection device according to claim 1, wherein
the first processor is configured to execute the instructions to set, in the modulation portion of the spatial light modulator, a composite image obtained by combining a virtual lens image for condensing the modulated beam forming the desired image on the reflective surface of the curved mirror with the phase image for forming the desired image.

3. The projection device according to claim 1, further comprising
a first shield disposed between the spatial light modulator and the curved mirror, and having a slit opened to allow the modulated beam forming the desired image to pass therethrough, the first shield being configured to shield an unnecessary light component included in the modulated beam.

4. The projection device according to claim 1, further comprising
a second shield disposed on an optical path of the projection beam reflected by the reflective surface of the curved mirror, and having a slit opened to allow the projection beam forming the desired image to pass therethrough, the second shield being configured to shield an unnecessary light component included in the projection beam.

5. The projection device according to claim 1, further comprising
a third shield disposed behind the curved mirror, the third shield being configured to shield an unnecessary light component included in the modulated beam forming the desired image.

6. The projection device according to claim 1, wherein
a condensing point for the beam emitted by the light source is set behind the curved mirror.

7. The projection device according to claim 1, further comprising
a 0th-order light remover configured to remove 0th-order light included in the modulated beam modulated by the modulation portion of the spatial light modulator, wherein
a condensing point for the beam emitted by the light source is set between the spatial light modulator and the curved mirror, and
the 0th-order light remover is disposed at a focal position of the beam.

8. The projection device according to claim 1, wherein
the reflective surface of the curved mirror has a curvature in a plane parallel to a horizontal plane.

9. The projection device according to claim 1, wherein
the reflective surface of the curved mirror has a curvature in a plane perpendicular to a horizontal plane.

10. The projection device according to claim 1, further comprising
a folding mirror configured to reflect an optical path of the modulated beam modulated by the modulation portion of the spatial light modulator toward the reflective surface of the curved mirror.

11. The projection device according to claim 10, wherein
the curved mirror includes a first curved mirror and a second curved mirror,
the first curved mirror has a curved first reflective surface irradiated with a part of the modulated beam modulated by the modulation portion of the spatial light modulator, reflects the modulated beam on the first reflective surface, and projects a first projection beam having a projection angle enlarged according to a curvature of the first reflective surface,
the folding mirror reflects a light component that is not reflected by the first reflective surface of the first curved mirror, out of the modulated beam modulated by the modulation portion of the spatial light modulator, toward the second curved mirror,
the second curved mirror has a curved second reflective surface irradiated with the light component reflected by the folding mirror out of the modulated beam modulated by the modulation portion of the spatial light modulator, reflects the light component on the second reflective surface, and projects a second projection beam having a projection angle enlarged according to a curvature of the second reflective surface, and
the first curved mirror and the second curved mirror are disposed in such a way that the first projection beam and the second projection beam are projected in different directions.

12. The projection device according to claim 11, wherein
the first curved mirror and the second curved mirror are disposed in such a way that the first projection beam and the second projection beam are projected in opposite directions.

13. The projection device according to claim 1, wherein
the light source includes
a plurality of emitters, and
a plurality of lenses that enlarge beams emitted by the plurality of emitters, respectively, according to a size of the modulation portion of the spatial light modulator.

14. A communication device comprising:
the projection device according to claim 1;
a reception device configured to receive a light signal transmitted from another communication device, and decode a signal based on the received light signal; and
a control device comprising a second memory storing instructions, and a second processor connected to the second memory and configured to execute the instructions to receive the signal decoded by the reception device, execute processing according to the received signal, and transmit a light signal according to the executed processing to the projection device.
